(19) United States
(12) Patent Application Publication
(10) Pub. No.: US 2026/0341953 A1
(43) Pub. Date: Oct. 29, 2026

(54) FOLDABLE ELECTRONIC DEVICE

(71) Applicant: HONOR DEVICE CO., LTD., Shenzhen (CN)

(72) Inventors: Chengli Liu, Shenzhen (CN); Tiezhu Liang, Shenzhen (CN); Yu Wang, Shenzhen (CN)

(21) Appl. No.: 19/711,352

(22) Filed: Jun. 17, 2026

Related U.S. Application Data
(63) Continuation of application No. PCT/CN2024/106915, filed on Jul. 23, 2024.

(30) Foreign Application Priority Data
Dec. 26, 2023 (CN) 202311815859.3

(51) Int. Cl. H01Q 1/22; H01Q 1/48; H01Q 1/52

(52) U.S. Cl. CPC H01Q 1/22; H01Q 1/48; H01Q 1/52

(57) ABSTRACT

Embodiments of this application disclose a foldable electronic device. The foldable electronic device includes a first main body, a second main body, and a rotating shaft. The first main body and the second main body are connected to each other through the rotating shaft, and the foldable electronic device is foldable at the rotating shaft. The first main body includes a first metal frame, and the first metal frame includes a first open end and a second open end. A first ground point and a second ground point are disposed on the first metal frame. A first feed point is disposed between the first ground point and the first open end, and a second feed point is disposed between the second ground point and the second open end. The second main body includes a second metal frame, and two ends of the second metal frame are open.

### CROSS-REFERENCE TO RELATED APPLICATIONS

This application is a continuation of International Application No. PCT/CN2024/106915, filed on Jul. 23, 2024, which claims priority to Chinese Patent Application No. 202311815859.3, filed on Dec. 26, 2023, both of which are incorporated herein by reference in their entireties.

### TECHNICAL FIELD

This application relates to the field of wireless communication technologies, and in particular, to a foldable electronic device.

### BACKGROUND

With the continuous development of mobile phones, frequency bands that mobile terminals need to support are increasingly more, and requirements for communication quality are also increasingly higher. However, when a foldable mobile phone is in a folded state, performance of wireless signal reception and transmission may degrade, affecting user communication experience.

### SUMMARY

Embodiments of this application disclose a foldable electronic device, to improve a radiation effect of an antenna.

According to a first aspect, this application discloses a foldable electronic device. The foldable electronic device includes a first main body, a second main body, and a rotating shaft. The first main body and the second main body are connected to each other through the rotating shaft, and the foldable electronic device is foldable at the rotating shaft. The first main body includes a first metal frame, and the first metal frame includes a first open end and a second open end. A first ground point and a second ground point are disposed on the first metal frame. A first feed point is disposed between the first ground point and the first open end, and a second feed point is disposed between the second ground point and the second open end. The second main body includes a second metal frame, and two ends of the second metal frame are open.

In this embodiment of this application, radiation branches of a first antenna and a second antenna are designed on the first metal frame to ensure structural support and aesthetic appeal of the metal frame, and also to facilitate miniaturization of antenna design. When the foldable electronic device is in a folded state, to prevent the second main body from blocking signals of the first antenna and the second antenna, causing poor signals, design of the second metal frame and the first metal frame may enable the second metal frame to further radiate a signal of the first antenna and/or a signal of the second antenna, so as to improve radiation performance of the antennas. In addition, feed points are respectively disposed between the first ground point and a corresponding open end and between the second ground point and a corresponding open end, to ensure isolation between feed antennas.

In a possible implementation, the second metal frame is of a floating structure. In this way, the second metal frame is designed as the floating structure, so that the second metal frame is coupled to the first metal frame, to further radiate a radiation signal of the first metal frame outward, so as to ensure antenna performance.

In a possible implementation, when the foldable electronic device is in the folded state, a projection of the second metal frame on a plane on which the first main body is located at least partially overlaps the first metal frame. In this way, the second metal frame and the first metal frame are very close to each other in the folded state, and a close spatial distance can ensure that the second metal frame can be coupled to the first metal frame, to achieve an antenna enhancement effect.

In a possible implementation, the at least partially overlapping specifically includes: The projection of the second metal frame on the plane on which the first main body is located overlaps at least half of a first segment of the first metal frame in a length direction, and the first segment of the first metal frame is a metal frame from the first open end to the first ground point; or the projection of the second metal frame on the plane on which the first main body is located overlaps at least half of a second segment of the first metal frame in a length direction, and the second segment of the second metal frame is a metal frame from the second open end to the second ground point. In this way, the foregoing design structures of the first metal frame and the second metal frame can ensure that the second metal frame can be coupled to the first metal frame, so that the first antenna further radiates outward.

In a possible implementation, the at least partially overlapping specifically includes: The projection of the second metal frame on the plane on which the first main body is located completely overlaps the first metal frame. In this way, the foregoing design structures of the first metal frame and the second metal frame can ensure that the second metal frame can be coupled to the first metal frame, so that a radiation effect is better.

In a possible implementation, the foldable electronic device further includes a first antenna and a second antenna that are disposed on the first main body. The first metal frame includes the first segment and the second segment, the first segment of the first metal frame is a metal frame from the first open end to the first ground point, and the second segment of the second metal frame is a metal frame from the second open end to the second ground point. The first antenna includes the first segment of the first metal frame, and the second antenna includes the second segment of the first metal frame. In this way, the first segment of the first metal frame may be used as a part of a radiation branch of the first antenna, and the second segment may be used as a part of a radiation branch of the second antenna, to achieve signal radiation.

In a possible implementation, when the first antenna is fed at a first frequency, the first metal frame generates, at the first frequency, a first current in a direction from the first feed point to the first ground point; and when the second metal frame is coupled to the first antenna, the second metal frame generates, at the first frequency, a second current in a direction from a third open end to a fourth open end, where the first current is in a same direction as the second current. In this way, when the first antenna is fed, the second metal frame generates a current in the same direction as the first segment, so that signal radiation intensity of the first antenna is enhanced, and antenna efficiency of the first antenna is improved.

In a possible implementation, the first metal frame generates, at a fourth frequency, a third current in a direction from the first open end to the second open end; and the second metal frame generates, at the fourth frequency, a fourth current in a direction from the fourth open end to the third open end, where the third current is in an opposite direction to the fourth current, and the fourth frequency is greater than the first frequency. In this way, at an out-of-band frequency (the fourth frequency) of the first antenna, a current direction in the second metal frame is opposite to a current direction in the first metal frame, so that out-of-band radiation signals are canceled, to enhance in-band antenna efficiency of the first antenna.

In a possible implementation, when the second antenna is fed at a second frequency, the first metal frame generates, at the second frequency, a fifth current in a direction from the second feed point to the second ground point; and when the second metal frame is coupled to the second antenna, the second metal frame generates, at the second frequency, a sixth current in a direction from a fourth open end to a third open end, where the fifth current is in a same direction as the sixth current. In this way, when the second antenna is fed, the second metal frame generates a current in a same direction as the second segment, so that signal radiation intensity of the second antenna is enhanced, and antenna efficiency of the second antenna is improved.

In a possible implementation, the first metal frame generates, at a fifth frequency, a seventh current in a direction from the second open end to the first open end; and the second metal frame generates, at the fifth frequency, an eighth current in a direction from the third open end to the fourth open end, where the seventh current is in an opposite direction to the eighth current, and the fifth frequency is greater than the second frequency. In this way, at an out-of-band frequency (the fifth frequency) of the second antenna, a current direction in the second metal frame is opposite to a current direction in the first metal frame, so that out-of-band radiation signals are canceled, to enhance in-band antenna efficiency of the second antenna.

In a possible implementation, a resonance frequency of the first antenna is the first frequency, a resonance frequency of the second antenna is the second frequency, and the first frequency and the second frequency both fall within a range of a cellular frequency band.

In an implementation, the first frequency is the same as the second frequency.

In a possible implementation, a distance between the first ground point and the first open end is less than a distance between the second ground point and the first open end; and a distance between the second ground point and the second open end is less than a distance between the first ground point and the second open end. In this way, the first ground point and the second ground point are limited at positions of the first metal frame, to ensure that corresponding radiation branches of the first antenna and the second antenna do not cross or overlap, so as to ensure reliability and suitability of radiation of the two antennas.

In a possible implementation, a length of the second metal frame is greater than or equal to ½ of a first wavelength, the first wavelength is a larger value of a first operating wavelength and a second operating wavelength, the first operating wavelength is a wavelength of a radiation signal of the first antenna, and the second operating wavelength is a wavelength of a radiation signal of the second antenna. In this way, the second metal frame can generate a resonance frequency greater than an operating frequency of the first antenna and/or the second antenna, so that a resonance is generated out of a frequency band higher than a communication frequency band of the first antenna and/or the second antenna, resulting in a local minimum value of antenna efficiency. By comparison, the operating efficiency of the first antenna and/or the second antenna can be improved.

In a possible implementation, the first segment of the first metal frame is connected to a first frequency modulation circuit, and the first frequency modulation circuit is configured to adjust a resonance frequency of the first antenna to the first frequency; the second segment of the first metal frame is connected to a second frequency modulation circuit, and the second segment is configured to adjust a resonance frequency of the second antenna to the second frequency; and the second metal frame is connected to a third frequency modulation circuit which is configured to adjust a resonance frequency of the second metal frame to a third frequency, where the third frequency is the same as the first frequency, and/or the third frequency is the same as the second frequency.

In a possible implementation, a third ground point is disposed on the second metal frame, the third frequency modulation circuit includes a fourth frequency modulation circuit and a fifth frequency modulation circuit, the fourth frequency modulation circuit is disposed on one side of the third ground point, and the fifth frequency modulation circuit is disposed on the other side of the third ground point. The fourth frequency modulation circuit and the fifth frequency modulation circuit can respectively adjust frequencies of the first antenna and the second antenna, to achieve a capability of respectively re-radiating radiation signals of the first antenna and the second antenna, and have a capability of separately adjusting the two antennas and enhancing radiation performance.

In a possible implementation, when the foldable electronic device is in the folded state, a projection of the third ground point on the plane on which the first main body is located is between the first ground point and the second ground point. In this way, the third ground point can be located in a middle position for signal isolation between the first antenna and the second antenna, so that in the folded state, the second metal frame is coupled to the first metal frame, to improve outward radiation performance.

In a possible implementation, when the foldable electronic device is in the folded state, a projection of the third ground point on the plane on which the first main body is located overlaps the first ground point or the second ground point. In this way, the third ground point can be located in a middle position for signal isolation between the first antenna and the second antenna, so that in the folded state, the second metal frame is coupled to the first metal frame, to improve outward radiation performance.

According to a second aspect, this application provides an antenna system. The antenna system includes any implementation of the foldable electronic device according to the first aspect.

### BRIEF DESCRIPTION OF DRAWINGS

FIG. 1A to FIG. 1C are a group of schematic diagrams of a structure of a foldable electronic device 100 according to an embodiment of this application;

FIG. 2A and FIG. 2B are a group of schematic diagrams of an antenna system of a foldable electronic device according to an embodiment of this application;

FIG. 3A to FIG. 3C are a group of schematic diagrams of a structure of an antenna system in an unfolded state according to an embodiment of this application;

FIG. 4A is a schematic diagram of S-parameter curves of a first antenna and a second antenna when an electronic device is in an unfolded state according to an embodiment of this application;

FIG. 4B is a schematic diagram of antenna efficiency curves of a first antenna and a second antenna when an electronic device is in an unfolded state according to an embodiment of this application;

FIG. 5A to FIG. 5C are a group of schematic diagrams of current flow directions in a first metal frame in FIG. 3B at different frequencies according to an embodiment of this application;

FIG. 6 is a schematic diagram of a structure of an antenna in a folded state according to an embodiment of this application;

FIG. 7 is a schematic diagram of a circuit structure of an antenna system in FIG. 6 according to an embodiment of this application;

FIG. 8A is a schematic diagram of S-parameter curves of a first antenna and a second antenna when an electronic device is in a folded state according to an embodiment of this application;

FIG. 8B is a schematic diagram of antenna efficiency curves of a first antenna and a second antenna when an electronic device is in a folded state according to an embodiment of this application;

FIG. 9A to FIG. 9D are a group of schematic diagrams of current flow directions in a first metal frame and a second metal frame at different frequencies according to an embodiment of this application;

FIG. 10A and FIG. 10B are another group of schematic diagrams of an antenna system of a foldable electronic device 100 according to an embodiment of this application;

FIG. 11 is a schematic diagram of a structure of an antenna when the electronic device in FIG. 10A is in a folded state according to an implementation of this application;

FIG. 12 is a schematic diagram of a circuit structure of an antenna system according to an implementation of this application;

FIG. 13A is a schematic diagram of S-parameter curves of a first antenna and a second antenna when an electronic device is in a folded state according to an implementation of this application;

FIG. 13B is a schematic diagram of antenna efficiency curves of a first antenna and a second antenna when an electronic device is in a folded state according to an implementation of this application;

FIG. 14A to FIG. 14C are another group of schematic diagrams of an antenna system of a foldable electronic device according to an implementation of this application;

FIG. 15 is a schematic diagram of a structure of an antenna when the electronic device in FIG. 14A is in a folded state according to an implementation of this application;

FIG. 16 is a schematic diagram of a circuit structure of an antenna when the electronic device in FIG. 15 is in a folded state according to an implementation of this application;

FIG. 17A is a schematic diagram of S-parameter curves of a first antenna and a second antenna when an electronic device is in a folded state according to an implementation of this application;

FIG. 17B is a schematic diagram of antenna efficiency curves of a first antenna and a second antenna when an electronic device is in a folded state according to an implementation of this application;

FIG. 18A and FIG. 18B are another group of schematic diagrams of an antenna system of a foldable electronic device 100 according to an implementation of this application;

FIG. 19A is a schematic diagram of S-parameter curves of a first antenna and a second antenna when an electronic device is in a folded state according to an implementation of this application;

FIG. 19B is a schematic diagram of antenna efficiency curves of a first antenna and a second antenna when an electronic device is in a folded state according to an implementation of this application;

FIG. 20A and FIG. 20B are another group of schematic diagrams of an antenna system of a foldable electronic device 100 according to an embodiment of this application;

FIG. 21A is a schematic diagram of S-parameter curves of a first antenna and a second antenna when an electronic device is in a folded state according to an implementation of this application; and

FIG. 21B is a schematic diagram of antenna efficiency curves of a first antenna and a second antenna when an electronic device is in a folded state according to an implementation of this application.

### DESCRIPTION OF EMBODIMENTS

The following clearly and completely describes technical solutions in implementations of this application with reference to the accompanying drawings in the implementations of this application. The accompanying drawings are for illustrative purposes only, and represent only schematic diagrams, which should not be construed as limiting this application. Apparently, the described implementations are only a part of rather than all of the implementations of this application. All other implementations obtained by a person of ordinary skill in the art based on the implementations of this application without creative efforts shall fall within the protection scope of this application.

Unless otherwise defined, all technical and scientific terms used in this application have same meanings as meanings usually understood by a person skilled in the art. In this application, terms used in this specification are merely intended to describe the specific implementations, but are not intended to limit this application.

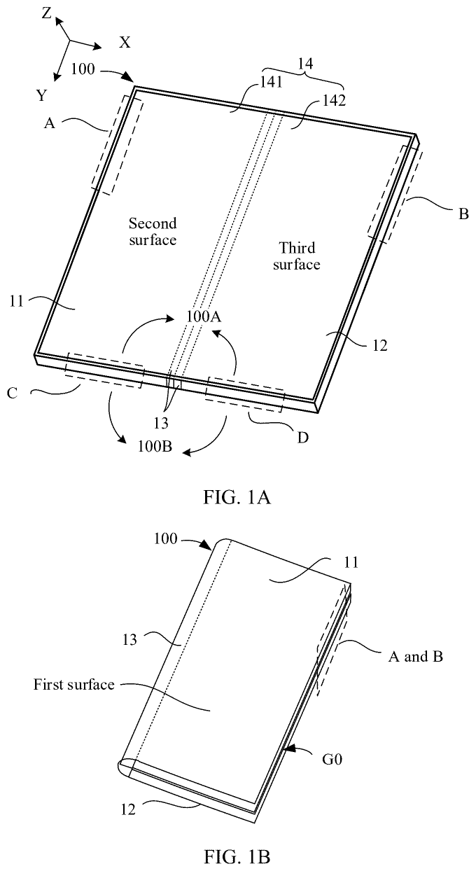

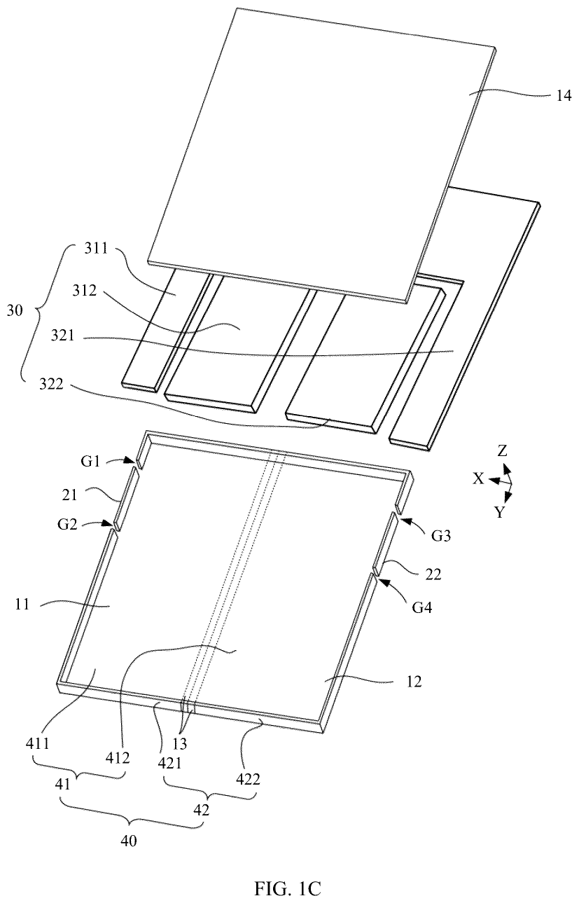

FIG. 1A and FIG. 1B are schematic diagrams of a structure of a foldable electronic device 100 according to an implementation of this application. The electronic device 100 includes, but is not limited to, an electronic apparatus, for example, a mobile phone, a tablet computer, or a wearable device.

As shown in FIG. 1A and FIG. 1B, the electronic device 100 includes a first main body 11 and a second main body 12 that are connected to each other. In this implementation of this application, the electronic device 100 further includes a rotating shaft 13 disposed between the first main body 11 and the second main body 12. The first main body 11 and the second main body 12 are connected to each other through the rotating shaft 13 and may be folded or unfolded relative to each other through the rotating shaft 13, to enable the electronic device 100 to have two use modes. FIG. 1A is a schematic diagram of a structure of the electronic device 100 in a use mode in an unfolded state. FIG. 1B and FIG. 1C are schematic diagrams of a structure of the electronic device 100 in a use mode in a folded state.

For ease of describing the folded state, the unfolded state, and dynamic switching between the folded state and the unfolded state of the foldable electronic device, as shown in FIG. 1A and FIG. 1B, the foldable electronic device may include four surfaces: a first surface, a second surface, a third surface, and a fourth surface. The first surface is a plane on which a first rear cover 421 of the first main body 11 is located, the second surface is a plane on which a display screen 14 corresponding to the first main body 11 is located, the third surface is a plane on which a display screen 14 corresponding to the second main body 12 is located, and the fourth surface is a plane on which a second rear cover 422 of the second main body 12 is located.

The foldable electronic device can be in a completely or nearly completely folded state by folding the first main body 11 and the second main body 12 inward. In this case, the first surface and the fourth surface are exposed, and the second surface and the third surface may be partially or completely in contact (as shown in FIG. 1B). Inward folding may be shown in FIG. 1A. The first main body 11 and the second main body 12 are folded in a first direction 100A.

Alternatively, the foldable electronic device can be in a completely or nearly completely folded state by folding the first main body 11 and the second main body 12 outward. In this case, the second surface and the third surface are exposed, and the first surface and the fourth surface may be partially or completely in contact. Outward folding may be shown in FIG. 1A. The first main body 11 and the second main body 12 are folded in a second direction 100B.

Alternatively, the foldable electronic device can be in the unfolded state by folding the first main body 11 and the second main body 12 outward or inward.

A connection structure (not shown in the figure), for example, a rotating shaft structure or a hinge structure, may be further disposed on the rotating shaft 13. The first main body 11 and the second main body 12 are connected to each other through the connection structure, and the first main body 11 and the second main body 12 may rotate through the connection structure, so that the first main body 11 and the second main body 12 can switch between a relatively folded state and a relatively unfolded state.

The electronic device 100 further includes the display screen 14 on the first main body 11 and the second main body 12. The display screen 14 is configured to display a visual output to a user, and the visual output may include a graph, a text, an icon, a video, and the like. The display screen 14 includes a first display part 141 and a second display part 142. The electronic device 100 in the folded state may have a display screen of a small area, so that a use requirement of the user for portability can be met. The display screen 14 may be a flexible screen. When the electronic device 100 is in the folded state, the display screen 14 may be hidden on an inner side of the electronic device 100, or may be exposed on an outer side of the electronic device 100. A type of the display screen 14 and a presentation manner of the display screen 14 when the electronic device 100 is in the folded state are not limited in this application. In FIG. 1B, for example, the display screen 14 is exposed on the outer side of the electronic device 100 when the electronic device 100 is in the folded state.

A left edge of the electronic device 100 in the unfolded state is a first edge region A; and a right edge of the electronic device 100 in the unfolded state is a second edge region B. In the folded state, a projection of a metal frame of the first main body 11 in the first edge region A on a plane on which the first main body 11 is located may at least partially overlap a metal frame of the second main body 12 in the second edge region B.

In an implementation of this application, available space inside the electronic device is compact. To save space, during antenna design, a segment of a metal frame is usually designed as a plurality of antennas having a same frequency or close frequencies. Poor isolation is an urgent problem that needs to be resolved. In addition, when the electronic device is in the folded state, because the second edge region B blocks and overlaps a signal in the first edge region A, antenna radiation efficiency in the first edge region A is low, and radiation performance is poor.

This application provides a foldable electronic device. The foldable electronic device includes a first main body, a second main body, and a rotating shaft. The first main body and the second main body are connected to each other through the rotating shaft, and the foldable electronic device is foldable at the rotating shaft. The first main body includes a first metal frame, and two ends of the first metal frame are open, including a first open end and a second open end. A first ground point and a second ground point are disposed on the first metal frame. The first ground point is connected to a first ground branch, and the second ground point is connected to a second ground branch. A first feed point is disposed between the first ground point and the first open end, and a second feed point is disposed between the second ground point and the second open end. The second main body includes a second metal frame, two ends of the second metal frame are open, and the second metal frame is not connected to a feed source. When the foldable electronic device is in a folded state, the fed first metal frame is coupled to the second metal frame, to radiate an electromagnetic wave outward.

A first antenna and a second antenna are disposed on the first main body. The first antenna includes a first segment of the first metal frame, one end of the first segment is open, and the other end of the first segment is grounded; and a feed point of the first antenna is disposed on the first segment. The second antenna includes a second segment of the first metal frame, one end of the second segment is open, and the other end of the second segment is grounded; and a feed point of the second antenna is disposed on the second segment.

In this embodiment of this application, radiation branches of the first antenna and the second antenna are designed on a segment of a metal frame (the first metal frame), to ensure structural support of the metal frame and aesthetic appeal of an antenna structure, and save space. However, designing antenna branches of two antennas on a same segment of a metal frame leads to poor isolation between the two antennas. In a structure of an antenna system of this application, in a process of feeding the first metal frame, a resonance may be formed, and a resonance frequency is different from a resonance frequency of the first antenna and is different from a resonance frequency of the second antenna, to improve isolation between the first antenna and the second antenna. In addition, when the electronic device is in the folded state, radiation signals of the first antenna and the second antenna may be further radiated at the second metal frame, to reduce signal radiation blocking and improve radiation efficiency of the first antenna and the second antenna.

With reference to FIG. 1A and FIG. 1B, the left edge of the electronic device 100 in the unfolded state is the first edge region A. The first edge region A includes the first metal frame. The first ground point and the first feed point of the first antenna are disposed on the first segment of the first metal frame, and the second ground point and the second feed point of the second antenna are disposed on the second segment of the first metal frame. In other words, two ends of the first metal frame are open, including the first open end and the second open end. The right edge of the electronic device 100 in the unfolded state is the second edge region B. The second edge region B may include the second metal frame, and the second metal frame may be of a floating structure.

Optionally, when the electronic device is in the folded state, a projection of the second metal frame on a plane on which the first main body is located at least partially overlaps the first metal frame, in other words, partially overlaps or completely overlaps the first metal frame.

The at least partially overlapping may include: The projection of the second metal frame on the plane on which the first main body is located overlaps at least half of the first segment of the first metal frame; or the projection of the second metal frame on the plane on which the first main body is located overlaps at least half of the second segment of the first metal frame. In this way, in the foregoing structure of the antenna system, radiation efficiency and performance of the first antenna and the second antenna in the folded state can be improved. It may be understood as: there is a minimum standard for a length of an overlapping region, that is, ½ of a length of the first segment of the first metal frame, or ½ of a length of the second segment of the first metal frame. When the projection of the second metal frame on the plane on which the first main body is located merely overlaps the first segment of the first metal frame, at least ½ of the length of the first segment of the first metal frame overlaps the projection of the second metal frame on the plane on which the first main body is located. When the projection of the second metal frame on the plane on which the first main body is located merely overlaps the second segment of the first metal frame, at least ½ of the length of the second segment of the first metal frame overlaps the projection of the second metal frame on the plane on which the first main body is located.

The at least partially overlapping may include: The projection of the second metal frame on the plane on which the first main body is located completely overlaps the first metal frame. Two open ends of the first metal frame are respectively aligned with two open ends of the second metal frame. It may be understood as that two ends of the second metal frame are open, including a third open end and a fourth open end, the third open end is aligned with the first open end, and the fourth open end is aligned with the second open end. The second metal frame and the first metal frame have equal lengths and are aligned in position. In this way, it can be ensured that the second metal frame and the first metal frame are fully coupled to each other, so that radiation efficiency is high and performance is good when the first metal frame is fed.

In FIG. 1A and FIG. 1B, spatial positions of the first metal frame and the second metal frame are merely examples indicated by using the fourth edge regions A and B, which are not limited thereto. For example, as shown in FIG. 1A, when the electronic device 100 is in the unfolded state, a left bottom frame is a third edge region C, and a right bottom frame is a fourth edge region D. In this case, the first metal frame may be disposed in the third edge region C, and the second metal frame may be disposed in the fourth edge region D. Certainly, the first metal frame and the second metal frame may alternatively be disposed on a top frame or at another position. Details are not described herein.

FIG. 1C is a schematic diagram of an exploded structure of the electronic device 100. As shown in FIG. 1C, the electronic device 100 includes at least a display screen 14, a housing 40, and an internal structure 30 in an accommodating cavity surrounded by the display screen 14 and the housing 40.

Specifically, the housing 40 includes a middle frame 41 and a rear cover 42. The middle frame 41 is connected to at least an edge region of the rear cover 42. The middle frame 41 includes a first middle frame 411 corresponding to the first main body 11 and a second middle frame 412 corresponding to the second main body 12. The rear cover 42 includes a first rear cover 421 corresponding to the first main body 11 and a second rear cover 422 corresponding to the second main body 12. An entirety formed by the first middle frame 411 and the first rear cover 421, and an entirety formed by the second middle frame 412 and the second rear cover 422 may be connected to each other through the rotating shaft 13.

Refer to FIG. 1B together. When the electronic device 100 is in a completely folded state, the first main body 11 and the second main body 12 are disposed in an overlapping manner, so that the first middle frame 411 and the second middle frame 412 are disposed in an overlapping manner, and the first rear cover 421 and the second rear cover 422 are disposed in an overlapping manner. The antenna may be disposed on the middle frame 41 and/or the rear cover.

In this implementation, the internal structure 30 includes, but is not limited to, a first circuit board assembly 311 and a first battery cell 312 that correspond to the first main body 11, and a second circuit board assembly 321 and a second battery cell 322 that correspond to the second main body 12. The first circuit board assembly 311 is configured to dispose an electronic component included in the first main body 11, and the second circuit board assembly 321 is configured to dispose an electronic component included in the second main body 12. The first battery cell 312 and the second battery cell 322 are configured to provide power for electronic components disposed on the first main body 11 and/or the second main body 12. In another implementation, the electronic device 100 may further include one battery cell or more than two battery cells.

It may be understood that the electronic device 100 shown in FIG. 1C is merely an example of the electronic device, and the electronic device 100 may have more or fewer components than those shown in FIG. 1C, may have a combination of two or more components, or may have a different component configuration.

In this embodiment of this application, the first antenna and the second antenna are both disposed on the first middle frame 411 corresponding to the first main body 11, and the first antenna and the second antenna are both disposed on a first metal frame 21. One end of the first metal frame 21 is spaced by a first gap G1, forming a first open end. The other end of the first metal frame 21 is spaced by a second gap G2, forming a second open end. A second metal frame 22 is disposed on the second middle frame 412 corresponding to the second main body 12. One end of the first metal frame 21 is spaced by a third gap G3, forming a third open end. The other end of the second metal frame 22 is spaced by a fourth gap G4, forming a fourth open end. Two ends of the second metal frame 22 are open and not connected to a feed point, forming a floating structure, which may also be referred to as a parasitic branch. In this embodiment of this application, an open end of a metal frame may indicate a structure in which one end of the metal frame is spaced by a gap.

In this first implementation, the first middle frame 411 may be partially or entirely made of a metal material, and the first metal frame 21 is a part of a structure of the first middle frame 411. The second middle frame 412 may be partially or entirely made of a metal material, and the second metal frame 22 is a part of a structure of the second middle frame 412.

Optionally, in another implementation, the first middle frame 411 may be partially or entirely made of a non-conductive material (for example, glass or plastic), the first metal frame 21 is adhered to an inner side of the first middle frame 411, and the second metal frame 22 is adhered to an inner side of the second middle frame 412.

Optionally, in another implementation, the first rear cover 421 may be made of a metal material, the first metal frame 21 is a part of a structure of the first rear cover 421, and the second metal frame 22 is a part of a structure of the second rear cover 422. For example, the first metal frame 21 and the second metal frame 22 may be cut-off metal accessories obtained by providing a slot on the first rear cover 421.

### Embodiment 1

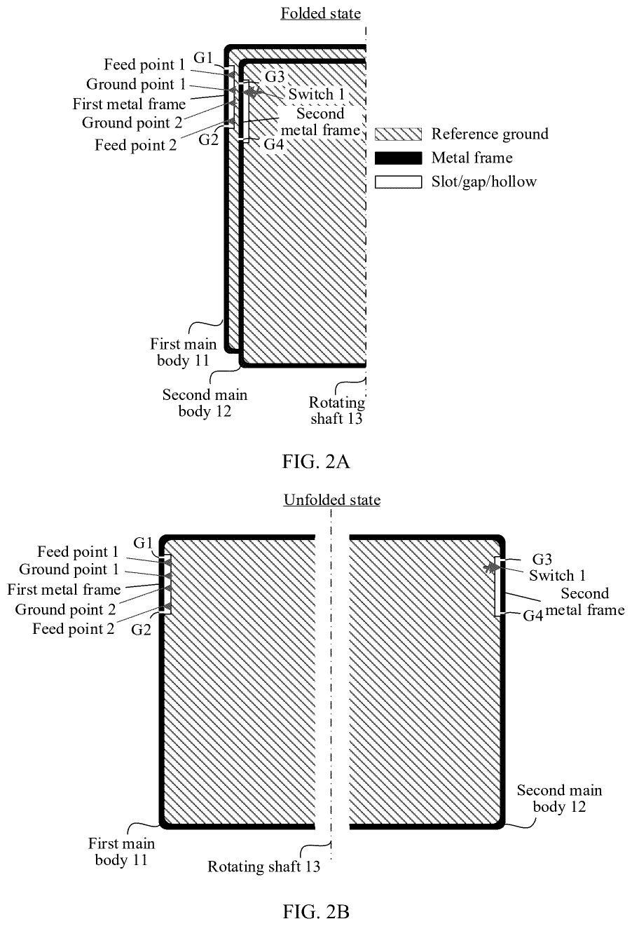

FIG. 2A and FIG. 2B are a group of schematic diagrams of an antenna system of a foldable electronic device according to an implementation of this application. FIG. 2A shows an antenna system formed when the electronic device is in a folded state, and FIG. 2B shows an antenna system formed when the electronic device is in an unfolded state.

As shown in FIG. 2A, in this case, a first main body 11 and a second main body 12 are folded through a rotating shaft 13, and the electronic device is in the folded state. To clearly present a structure of an antenna system that includes a first antenna, a second antenna, and a second metal frame, projection images of the first main body and the second main body on a plane on which the first main body is located are arranged in a staggered manner (where actual projections completely overlap, and the second main body 12 blocks a structure of an antenna system of the first main body). The first main body 11 includes a first metal frame, and the second main body 12 includes a second metal frame.

Two ends of the first metal frame are open, including a first open end and a second open end. The first metal frame forms a strip-shaped conductor through a gap G1 and a gap G2. The first metal frame includes a first segment and a second segment. The first segment is a segment from the first open end to a ground point 1, and the second segment is a segment from the second open end to a ground point 2. The first metal frame may be provided with the ground point 1 and a feed point 1 of the first antenna, and the ground point 2 and a feed point 2 of the second antenna. There is the gap G1 between the first open end of the first segment of the first metal frame and a middle frame (a main screen frame) of the first main body, and there is the gap G2 between the second open end of the second segment of the first metal frame and the middle frame (the main screen frame) of the first main body.

A distance between the ground point 1 and the first open end is less than ¼ of a first operating wavelength. A distance between the ground point 2 and the second open end is less than ¼ of a second operating wavelength. The first operating wavelength is a wavelength of a radiation signal of the first antenna, and the second operating wavelength is a wavelength of a radiation signal of the second antenna. Operating means a state in which an antenna generates a radiation signal during feeding.

The distance between the ground point 1 and the first open end is less than a distance between the ground point 2 and the first open end; and the distance between the ground point 2 and the second open end is less than a distance between the ground point 1 and the second open end.

In an optional embodiment, a frequency band of the radiation signal of the first antenna is at least partially the same as a frequency band of the radiation signal of the second antenna. The first antenna and the second antenna may both operate within a cellular frequency band (MHB). For example, both the first antenna and the second antenna operate within a B3 frequency band (1.71 GHz to 1.88 GHZ). The first antenna and the second antenna may alternatively operate within another frequency band. For example, the first antenna operates within a communication frequency band of a global positioning system (Global Positioning System, GPS), and the second antenna operates within the B3 frequency band. For another example, the first antenna operates within a Wi-Fi frequency band, and the second antenna operates within a B40 frequency band (2.3 GHz to 2.4 GHZ). Operating frequency bands of the two antennas are at least partially the same, so that interference may be generated between the first antenna and the second antenna.

When the electronic device is in the folded state, the first metal frame and the second metal frame are very close in a Z-axis direction (in a thickness direction of the electronic device). As shown in FIG. 1B, a plane on which the first metal frame is located and a plane on which the second metal frame is located may be a same plane. A distance between the first metal frame and the second metal frame in the thickness direction is a first distance, and the first distance may be 0 mm to 20 mm. In this way, when the second metal frame can further radiate an antenna signal of the first metal frame, radiation performance is better.

Two ends of the second metal frame are open, including a third open end and a fourth open end. There is a gap G3 between the second metal frame and a middle frame (a secondary screen frame) of the second main body 12, forming the third open end; and there is a gap G4 between the second metal frame and the middle frame (the secondary screen frame) of the second main body 12, forming the fourth open end. The second metal frame is not connected to a feed source. A length of the second metal frame is greater than ½ of a first wavelength, and the first wavelength is a larger value of the first operating wavelength and the second operating wavelength. The second metal frame may be of a parasitic structure.

Parts with diagonal lines in FIG. 2A and FIG. 2B represent reference ground, for example, a printed circuit board (printed circuit board, PCB) floor. The first main body 11 may include first reference ground, and the second main body 12 may include second reference ground. A black-filled part represents a metal frame, for example, the first metal frame and the second metal frame. A blank-patterned part represents a slot/gap/hollow. A hollow interior formed between the metal frame and the reference ground, that is, a hollow formed between the floating metal frame and the reference ground enables a radiation branch to float above the ground, and a clearance area is formed. The gaps in the metal frame and the internal hollow may be filled with an isolating medium. In addition, the feed point may be connected to the feed source.

Radiation branches of the two antennas corresponding to the first metal frame may be a left-hand antenna, an inverted F-shaped antenna (inverted F-shaped antenna, IFA), or the like. For example, the first antenna and the second antenna are left-hand antennas, and are configured to cover a cellular frequency band (MHB, generally in an operating range of 1.6 GHz to 2.8 GHz).

The second metal frame may include an antenna in a form of a metal microstrip disk antenna (Microstrip Disk Antenna, MDA), a flexible printed circuit (Flexible Printed Circuit, FPC), or the like. This is not limited in this application.

It should be noted that the first main body and the second main body may alternatively include an antenna of another type. This is not limited in this application.

In addition, for a case in which projections of metal frames overlap each other when the electronic device is in the folded state, refer to the related descriptions in FIG. 1A and FIG. 1B. Details are not described herein again.

With reference to two antenna states in FIG. 2A and FIG. 2B, radiation conditions of the antennas in the folded state and in the unfolded state are separately described.

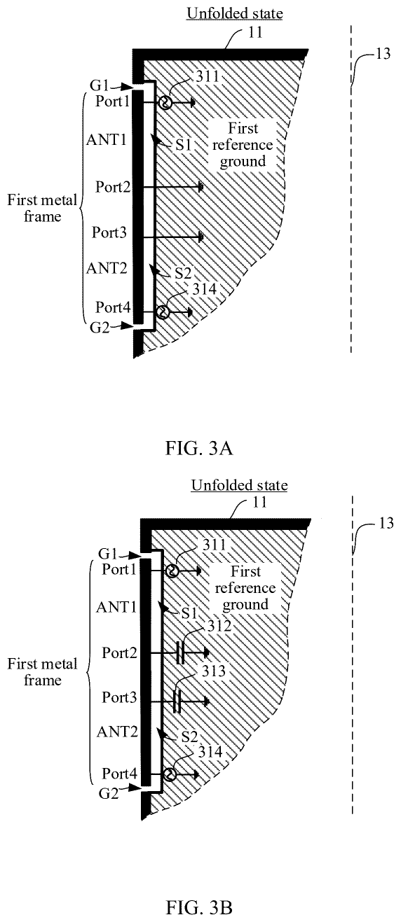

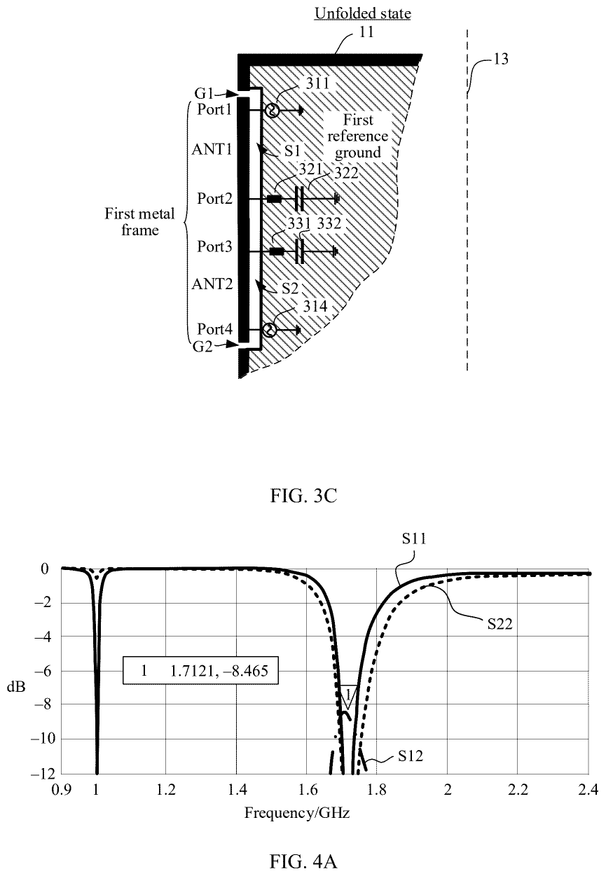

FIG. 3A to FIG. 5C illustrate a structure and performance of an antenna in the unfolded state.

FIG. 3A to FIG. 3C are a group of schematic diagrams of a structure of an antenna system in an unfolded state according to an example embodiment of this application. In FIG. 3A to FIG. 3C, radiation branches of a first antenna ANT1 and a second antenna ANT are both disposed on the first metal frame. Two ground points of the first metal frame block radiation signals of the two antennas, to improve isolation between the two antennas.

As shown in FIG. 3A to FIG. 3C, a slot S1 is formed between the first segment of the first metal frame and the first reference ground, and a slot S2 is formed between the second segment of the first metal frame and the first reference ground, forming a clearance area. The radiation branches of the first antenna ANT1 and the second antenna ANT2 each have two ports port. The first segment of the first metal frame may include two interfaces, that is, port1 and port2. Port1 may be connected to one end of a first feed source 311, and the other end of the first feed source 311 is grounded. The second segment of the first metal frame may include two interfaces, that is, port3 and port4. Port4 is connected to one end of a second feed source 314, and the other end of the second feed source 314 is grounded. In the first metal frame, ports from one end to the other end are sequentially port1, port2, port3, and port4. Port1 and port4 are respectively located at two sides of the first metal frame close to the two open ends, and port2 and port3 are respectively located at the middle of the first metal frame far from the two open ends. For a specific position relationship of port1, port2, port3, and port4, refer to a position relationship among the feed point 1, the ground point 1, the ground point 2, and the feed point 2 in FIG. 2A and FIG. 2B. Details are not described herein again.

In the first metal frame, port2 and port3 need to be grounded (connected to ground ports). For the foregoing structure, FIG. 3A to FIG. 3C provide three different ground solutions.

### Ground Solution 1: Directly Grounded

As shown in FIG. 3A, port2 is directly grounded, and port3 is directly grounded. In this case, port2 and port3 of the two antennas need to be grounded, so that a barrier is formed.

### Ground Solution 2: Grounded Through a Capacitor

As shown in FIG. 3B, port2 is grounded through a capacitor 312, and port3 is grounded through a capacitor 313. An LC resonance can be generated by introducing the capacitors, to improve isolation between the first antenna ANT1 and the second antenna ANT2 in the unfolded state. When a distance between port2 and port3 is long, good isolation can be achieved by using the capacitors as barriers.

For example, when the capacitor 312 may be set to 6 pF, the capacitor 313 is set to 15 pF, and the first antenna ANT1 and/or the second antenna ANT2 operate/operates within a communication frequency band of B3 (1.71 GHz to 1.88 GHZ), an LC resonance of 1.1 GHz to 1.3 GHz may be generated between port2 and port3 of the first metal frame, and after the LC resonance is generated, isolation between the two antennas can be improved. Selection of a capacitance parameter is related to the distance between port2 and port3, the communication frequency band, and the like. Therefore, the capacitance parameter needs to be flexibly adjusted, and is not limited. Operating means a state in which an antenna generates a radiation signal during feeding.

### Ground Solution 3: Grounded Through an Inductor and a Capacitor

As shown in FIG. 3C, port2 is coupled to one end of an inductor 321, the other end of the inductor 321 is coupled to one end of a capacitor 322, and the other end of the capacitor 322 is grounded. Similarly, port3 is coupled to one end of an inductor 331, the other end of the inductor 331 is coupled to one end of a capacitor 332, and the other end of the capacitor 332 is grounded. An LC resonance can be generated between port2 and port3 of the first metal frame by connecting to the inductors and the capacitors, that is, a ground distance between the first antenna ANT1 and the second antenna ANT2 is lengthened, so that isolation between the two antennas can be better improved when the distance between port2 and port3 is short.

In addition, in the ground solution in FIG. 3C, positions of the inductor and the capacitor may be exchanged, and the LC resonance may also be generated, to improve the isolation.

In the ground solutions 2 and 3, a first ground point and a second ground point form an LC resonance structure, and the LC resonance structure is used for implementing isolation between radiation signals of the first antenna and the second antenna, that is, decoupling between the first antenna and the second antenna. In this case, a resonance frequency of the LC resonance structure is less than frequencies of the radiation signals of the first antenna and the second antenna. For example, operating frequencies of the first antenna and the second antenna are 1.72 GHz, and a resonance frequency of the LC resonance structure is 1.3 GHZ.

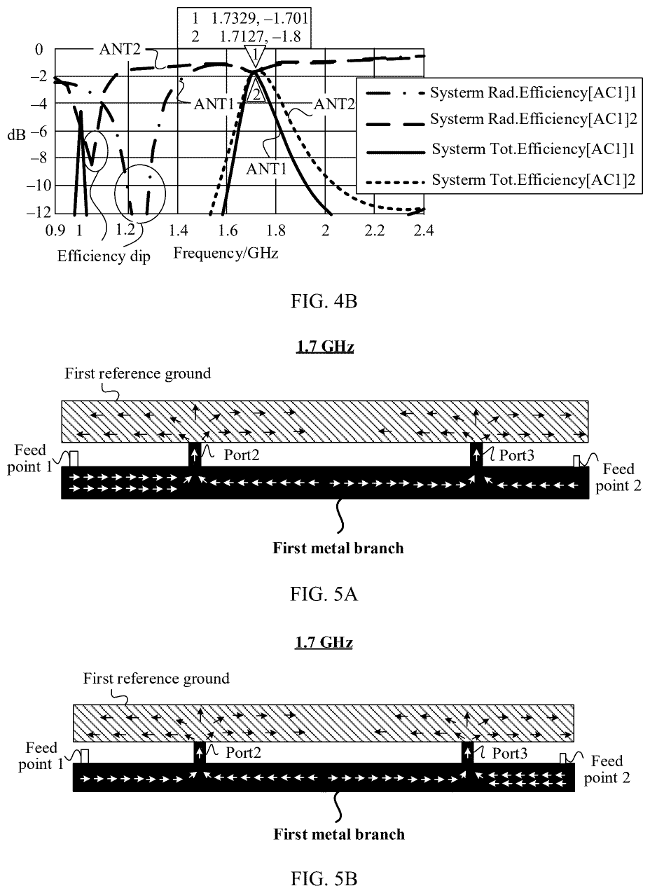

FIG. 4A is a schematic diagram of S-parameter curves of a first antenna and a second antenna when an electronic device is in an unfolded state. Reference numerals S11 and S22 respectively indicate reflection coefficient curves of the first antenna ANT1 and the second antenna ANT2, and a reference numeral S12 indicates a transmission coefficient curve between the first antenna ANT1 and the second antenna ANT2.

As shown in FIG. 4A, a resonance is generated between the first antenna ANT1 and the second antenna ANT2 within a B3 frequency band, and isolation is approximately −8.5 dB.

FIG. 4B is a schematic diagram of antenna efficiency curves of a first antenna and a second antenna when an electronic device is in an unfolded state. Reference numerals Systerm Rad.Efficiency[AC1]1 and Systerm Rad.Efficiency[AC1]2 respectively indicate radiation efficiency curves of the first antenna ANT1 and the second antenna ANT2, and reference numerals Systerm Tot.Efficiency[AC1]1 and Systerm Tot.Efficiency[AC1]2 respectively indicate system efficiency curves of the first antenna ANT1 and the second antenna ANT2.

As shown in FIG. 4B, within a B3 frequency band, antenna efficiency of the first antenna and the second antenna is approximately-2 dB. Because the ports port2 and port3 in FIG. 3C are grounded through the capacitors, it can be learned from the radiation efficiency curves of the first antenna ANT1 and the second antenna ANT2 that a resonance is generated (that is, LC is generated) within a frequency band of 1.1 GHz to 1.3 GHZ, so that the efficiency curves are sunken downward, and there is a local minimum value of the antenna efficiency. Therefore, isolation between the two antennas in the unfolded state can be improved. An efficiency dip indicates a case in which radiation efficiency of an antenna first decreases and then increases in a local range, forming specific lowest efficiency. Certainly, when a dip frequency formed by the LC is closer to a resonance frequency of the antenna, isolation between the two antennas increases, but the antenna efficiency is slightly reduced.

FIG. 5A to FIG. 5C are a group of schematic diagrams of current flow directions in the first metal frame in FIG. 3B at different frequencies.

FIG. 5A is a schematic diagram of current flow directions in the first metal frame when an operating frequency of the first antenna ANT1 is 1.7 GHz. In FIG. 5A, in the first segment of the first metal frame, port2 is connected to the first ground point, and a current flows from the feed point 1 to port2 and back to the ground. In the second segment of the first metal frame, port3 is connected to the second ground point, and a current flows from the feed point 2 to port3 back to the ground. In addition, currents between port3 and port2 also flow back to the ground through port3 and port2, respectively. FIG. 5A shows that the feed point 1 of the first antenna is fed to generate a radiation signal, the feed point 2 of the second antenna is not fed, and the current from the feed point 1 to port2 is stronger.

FIG. 5B is a schematic diagram of current flow directions in the first metal frame when an operating frequency of the second antenna ANT2 is 1.7 GHZ. Different from FIG. 5A, the feed point 1 of the first antenna is not fed, and the feed point 2 of the second antenna is fed to generate a radiation signal. Therefore, the current from the feed point 2 to port3 is stronger.

FIG. 5C is a schematic diagram of current flow directions in the first metal frame when an operating frequency of the first antenna ANT1 is from 1.7 GHZ to 2.7 GHZ. In FIG. 5C, the feed point 1 of the first antenna is fed to generate a radiation signal, the feed point 2 of the second antenna is not fed, and an LC resonance within a frequency band of 1 GHz to 1.3 GHz is generated between port2 and port3, so that a current forms a stopband (where a loop is formed between port2 and port3), and a current from port3 may flow back to the ground from port2 but cannot flow to the feed point 1, so that the currents between the two antennas are isolated, to improve isolation.

Certainly, if the feed point 2 of the second antenna is fed to generate a radiation signal, and the feed point 1 of the first antenna is not fed, a formed current flow direction diagram is mirror symmetric to the current flow direction diagram in FIG. 5C. Similarly, the LC is generated between port2 and port3, only current directions are opposite. Details are not described herein.

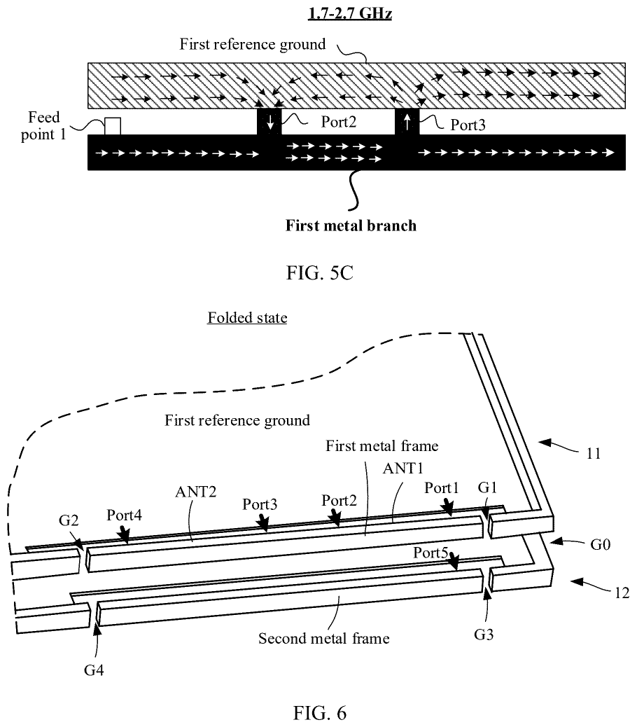

FIG. 6 to FIG. 9D illustrate a structure and performance of an antenna in the folded state.

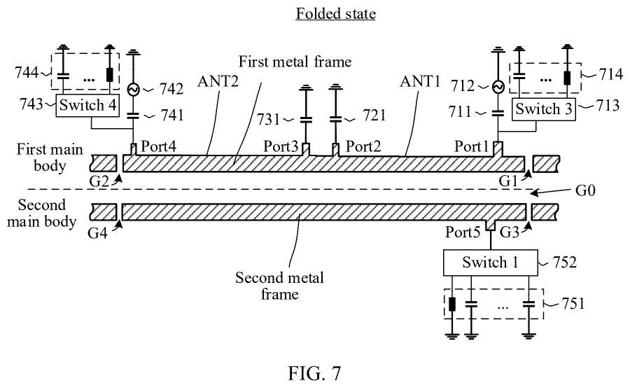

FIG. 6 is a schematic diagram of a structure of an antenna in a folded state according to an example embodiment of this application. As shown in FIG. 6, radiators (the first metal frame) of the two antennas of the first main body are placed in parallel with a floating structure (the second metal frame) of the second main body, that is, the secondary screen frame constructs the floating structure. A structure of the first metal frame in the folded state is the same as that in the unfolded state. For descriptions of port2 and port3, refer to the related descriptions in FIG. 3A to FIG. 3C. For port1 and port4, refer to the related descriptions in FIG. 3A to FIG. 3C and FIG. 7. Details are not described herein again. With reference to the folded state in FIG. 2A, for descriptions of the first metal frame and the second metal frame, refer to the related descriptions in FIG. 2A and FIG. 2B, and FIG. 1A to FIG. 1C. Details are not described herein again.

Different from the unfolded state, when the electronic device is in the folded state, in a process of feeding the first antenna and/or the second antenna of the first metal frame, radiation signals of the first antenna and/or the second antenna may be further radiated on the second metal frame, to improve radiation efficiency of the two antennas on the first metal frame. For the gap G3 and the gap G4 formed in the second metal frame, refer to the related descriptions in FIG. 2A and FIG. 2B. Details are not described herein again. A port port5 is disposed on the second metal frame, and port5 may be connected to a frequency modulation circuit. The frequency modulation circuit connected to port5 may perform frequency modulation based on operating frequency bands of the two antennas, so that a signal radiation frequency band of the second metal frame can be adapted to a current communication frequency band of the first antenna and/or a current communication frequency band of the second antenna, to improve efficiency of the first antenna ANT1 and the second antenna ANT2.

FIG. 7 is a schematic diagram of an example of a circuit structure of the antenna system in FIG. 6. As shown in FIG. 7, the port port1 of the first antenna ANT1 and the port port4 of the second antenna ANT2 are connected to the feed points, and further connected to frequency modulation circuits.

In this embodiment of this application, the frequency modulation circuit may include at least one switch (for example, a single-pole multi-throw switch) and several capacitors and/or inductors. One end of the switch is connected to a port of the first metal frame or the second metal frame, a plurality of selection ends of the switch are connected to ends of capacitors and/or inductors, and the other ends of the capacitors and/or the inductors are grounded. In this way, the switch may select one of the capacitors or inductors to be connected, to adjust an electrical length during antenna communication, so as to adjust an operating frequency, thereby improving flexibility and adaptability of antenna communication. Certainly, a specific structure of the frequency modulation circuit may be adjusted. For example, a plurality of switches are interactively controlled to select a capacitor or an inductor. For another example, one selection end of the switch may be directly grounded. The switch may be a metal dome.

Specifically, the first segment of the first metal frame is connected to a first frequency modulation circuit which is configured to adjust an operating frequency of the first antenna to a first frequency. The port port1 may be connected to one feed point and one frequency modulation circuit. The port Port1 may be connected to one end of a capacitor 711 and one end of a switch 3 (713), the other end of the capacitor 711 is connected to one end of a first feed point 712, and the other end of the first feed point 712 is grounded. (The first frequency modulation circuit includes the switch 3 and K capacitive sensing devices.) K selection ports of the switch 3 (713) are sequentially connected to ends of capacitors or inductors 714, and the other ends of the capacitors or inductors 714 are grounded. The capacitors or inductors 714 include the K capacitive sensing devices, where K is an integer greater than 2, and parameters of the capacitors or the inductors need to be different.

Correspondingly, the second segment of the first metal frame is connected to a second frequency modulation circuit which is configured to adjust an operating frequency of the second antenna to a second frequency. The port port4 may be connected to one feed point and one frequency modulation circuit. The port port4 may be connected to one end of a capacitor 741 and one end of a switch 4 (743) (where the second frequency modulation circuit includes the switch 4 and M capacitive sensing devices), the other end of the capacitor 741 is connected to one end of a second feed point 742, and the other end of the second feed point 742 is grounded. M selection ports of the switch 4 (743) are sequentially connected to ends of capacitors or inductors 744, and the other ends of the capacitors or inductors 744 are grounded. The capacitors or inductors 744 include M capacitive sensing devices, where M is an integer greater than 2, and parameters of the capacitors or the inductors need to be different. In this embodiment of this application, for ease of understanding, circuit structures of the first antenna ANT1 and the second antenna ANT2 may be roughly regarded as a centrosymmetric structure.

Optionally, one feed point and one frequency modulation circuit (port1 and port4) may be connected through different ports. For example, the first segment of the first metal frame further includes port9. The electronic device may connect the first frequency modulation circuit to port9, and the first feed point 712 is connected to port1. In addition, in a circuit in which a metal frame is connected to a feed point, a capacitor is not used for connection. For example, port1 is directly connected to the first feed point 712. The foregoing case is not limited in this application.

The second metal frame is connected to a third frequency modulation circuit which is configured to adjust a frequency of the second metal frame to a third frequency. Port5 of the second metal frame may also be connected to the third frequency modulation circuit. Port5 may be connected to one end of a switch 1 (752) (where the third frequency modulation circuit includes the switch 1 and N capacitive sensing devices), N selection ends of the switch 1 (752) may be connected to ends of capacitors or inductors 751, and the other ends of the capacitors or inductors 751 are grounded. N is also an integer greater than 2. The switch 1 (752) may be configured to select capacitor or inductor modules of different specifications to be grounded, to enable adaptation to a suitable frequency band and electrical length. During selection of the switch 1, an electrical length of the inductor is shortened, an electrical length of the capacitor is increased, and values of the shortened and increased electrical lengths of the inductor are related to device parameter values. The LC may lead to a slight reduction in antenna efficiency, and a suitable capacitor or inductor may be selected based on a compliance status of isolation and efficiency. The switch 1 may be a metal dome, configured to select a communication frequency band. For example, the switch 1 may have a total of eight adjustable states, and each state corresponds to a different communication frequency band, for example, B0, B3, B1, and B41.

For ground solutions of the ports port2 and port3, refer to the descriptions in FIG. 3B. The port port2 of the first antenna ANT1 may be connected to one end of a capacitor 721, and the other end of the capacitor 721 may be grounded. The port port3 of the second antenna ANT2 may be connected to one end of a capacitor 731, and the other end of the capacitor 731 may be grounded. In addition, the ground solutions of port2 and Port3 may alternatively be the solutions in FIG. 3A and FIG. 3C. This is not limited in this application.

Through selection of the switch 1, the switch 3, and the switch 4, the first antenna and the second antenna can determine corresponding frequency bands for communication. For example, communication is currently performed within a B3 frequency band, and parameters of the connected capacitors and inductors are as follows: The capacitor 714 is set to 0.3 pF; the capacitor 711 is set to 0.4 pF; the capacitor 721 is set to 6 pF; the capacitor 731 is set to 15 pF; the inductor 744 is set to 20 nH; and the capacitance 741 is set to 0.5 pF. A value of a capacitor in the capacitor or inductor 751 is set to 39 nH. When the switch 1 selects the capacitor, it is equivalent to that port5 of the second metal frame is grounded through the 39 nH capacitor.

With reference to an antenna structure shown in FIG. 7, a method for improving antenna efficiency is described.

The electronic device adjusts the operating frequency of the first antenna by adjusting the first frequency modulation circuit. Devices connected to a plurality of selection ends of a switch in the first frequency modulation circuit are different, and corresponding radiation frequencies of the first antenna are different. The electronic device may store a first mapping relationship between switch options and frequencies in the first frequency modulation circuit. When the electronic device determines that the first antenna needs to communicate at the first frequency, the electronic device may select a corresponding switch option from the first mapping relationship as a target switch option based on the first frequency. The electronic device may control an open loop of the first frequency modulation circuit to be adjusted to the target switch option. In this way, the electronic device adjusts the operating frequency of the first antenna to the first frequency by adjusting the first frequency modulation circuit.

Refer to the foregoing method for adjusting the operating frequency of the first antenna. The electronic device may adjust the operating frequency of the second antenna to the second frequency by adjusting the second frequency modulation circuit. The electronic device may also adjust a radiation frequency of the second metal frame to the third frequency by adjusting the third frequency modulation circuit. Details are not described herein again.

Further, before adjusting the radiation frequency of the second metal frame to the third frequency, the electronic device needs to first determine the third frequency. When determining that the radiation efficiency of the first antenna needs to be improved, the electronic device determines the third frequency as the operating frequency of the first antenna, that is, the third frequency is equal to the first frequency. When determining that the radiation efficiency of the second antenna needs to be improved, the electronic device determines the third frequency as the operating frequency of the second antenna, that is, the third frequency is equal to the second frequency.

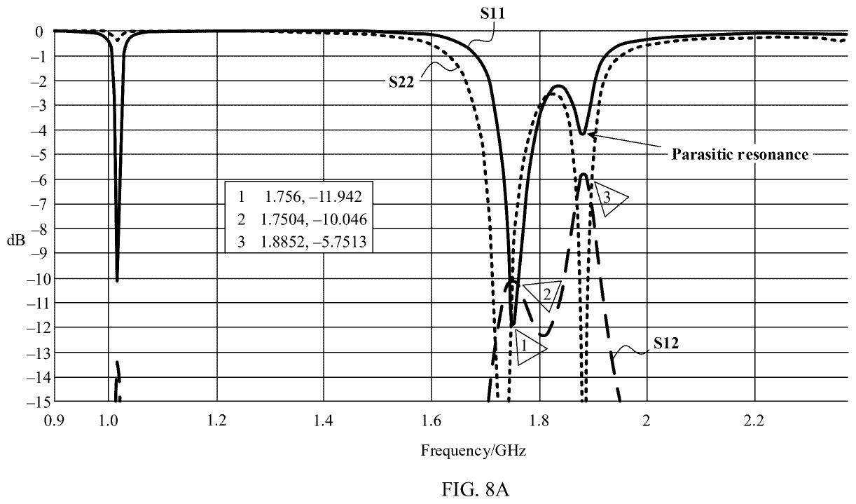

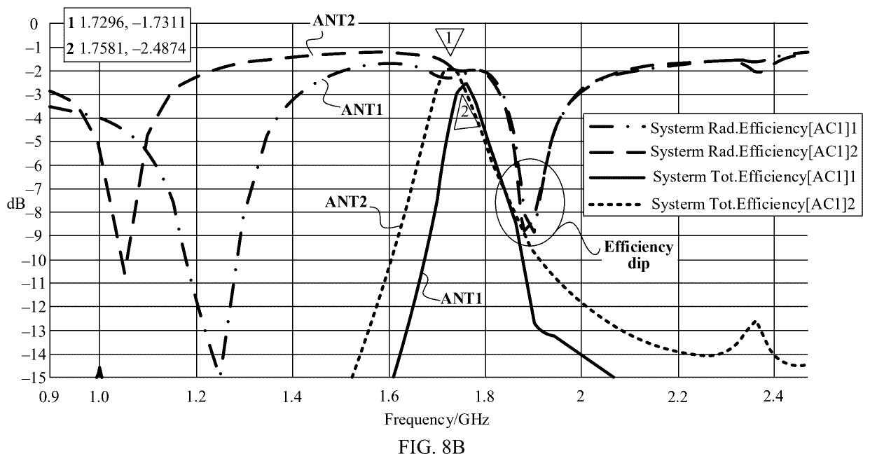

FIG. 8A is a schematic diagram of S-parameter curves of a first antenna and a second antenna when an electronic device is in a folded state. (In the structure of the antenna system in FIG. 6) Reference numerals S11 and S22 respectively indicate reflection coefficient curves of the first antenna ANT1 and the second antenna ANT2. A reference numeral S12 indicates a transmission coefficient curve between the first antenna ANT1 and the second antenna ANT2. It can be learned from a curve S12 that a resonance is generated at around 1.7 GHZ, and isolation is −10 dB. In addition, the second metal frame generates a parasitic resonance following a resonance between the first antenna ANT1 and the second antenna ANT2.

FIG. 8B is a schematic diagram of antenna efficiency curves of a first antenna and a second antenna when an electronic device is in a folded state. (In the structure of the antenna system in FIG. 6) Reference numerals Systerm Rad.Efficiency[AC1] and Systerm Rad.Efficiency[AC1]2 respectively indicate radiation efficiency curves of the first antenna ANT1 and the second antenna unit ANT2, and reference numerals Systerm Tot.Efficiency[AC1] and Systerm Tot.Efficiency[AC1]2 respectively indicate system efficiency curves of the first antenna ANT1 and the second antenna ANT2. It can be learned from two radiation efficiency curves that the second metal frame generates a parasite resonance within 1.8 GHz to 2 GHz. The parasite resonance is presented in the efficiency curve as a minimum value occurring between 1.8 GHz and 2 GHz. This can improve efficiency of the two antennas in the folded state and also improve isolation of the two antennas.

Based on the structures and the simulation results of the electronic device in the unfolded state and in the folded state, comparison may be performed as follows.

TABLE 1

| | First antenna ANT1 | | Second antenna ANT2 | | |
|---|---|---|---|---|---|
| | Frequency | Efficiency | Frequency | Efficiency | S21 |
| | (GHz) | (dB) | (GHz) | (dB) | (dB) |
| Unfolded state | 1.71 | −1.8 | 1.73 | −1.7 | −8.5 |
| Folded state | 1.75 | −2.5 | 1.73 | −1.7 | −10 |
| Efficiency | | −0.7 | | 0 | 1.5 |
| change | | | | | |

Table 1 shows comparison data of performance of the antennas in the folded state and in the unfolded state in Embodiment 1 according to an example embodiment of this application. In comparison to the unfolded state, in the folded state, isolation is improved by 1.5 dB, efficiency of the first antenna ANT1 changes by 0.7 dB, and efficiency of the second antenna ANT2 remains unchanged. In this way, when a structure design of the floating structure is added, in the folded state, the isolation between the two antennas and efficiency of one of the antennas can be improved. Therefore, in the folded state, compared to the unfolded state, efficiency is slightly reduced, and the isolation is improved.

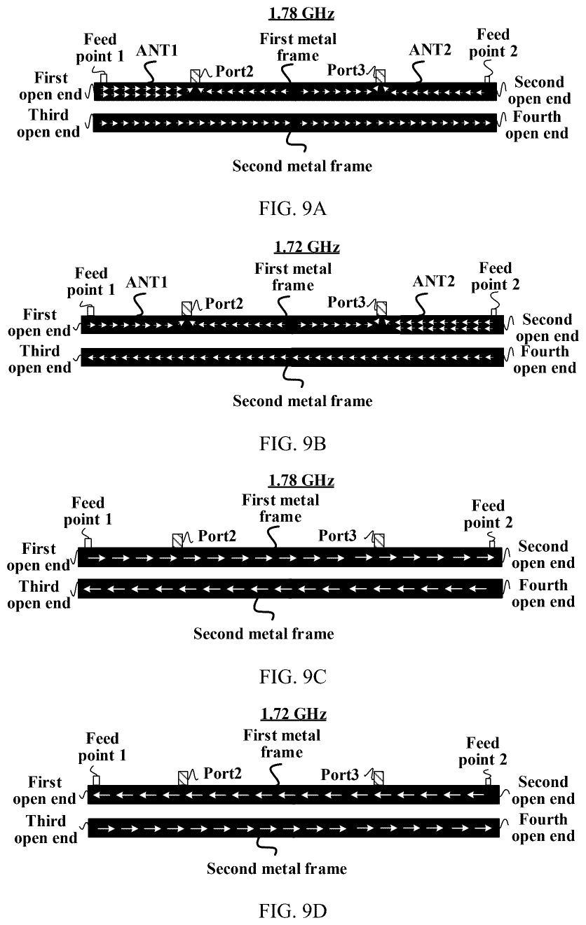

FIG. 9A to FIG. 9D are schematic diagrams of current flow directions in a first metal frame and a second metal frame at different frequencies (corresponding to the structure of the antenna system in FIG. 6).

FIG. 9A is a schematic diagram of current flow directions in the first metal frame and the second metal frame when an operating frequency of the first antenna ANT1 is 1.78 GHz. The feed point 2 of the second antenna is not fed, and the feed point 1 of the first antenna is fed to generate a radiation signal. For current flowing in the first metal frame, refer to the related descriptions in FIG. 5A. Details are not described herein again. A current direction in the second metal frame is the same as a current direction from the feed point 1 to port2, so that radiation efficiency of the first antenna in the first metal frame is enhanced.

In FIG. 9A, the electronic device is in the folded state. If the first antenna is fed to generate a radiation signal at a first operating frequency, the first metal frame generates a current 1 in a direction from the feed point 1 to port2 at the first operating frequency. In the foregoing process, the second metal frame couples a radiation signal within the first operating frequency band of the first antenna, and the second metal frame generates a current 2 in a direction from the third open end to the fourth open end within the first operating frequency band. The current 1 is in a same direction as the current 2.

FIG. 9B is a schematic diagram of current flow directions in the first metal frame and the second metal frame when an operating frequency of the second antenna ANT2 is 1.72 GHz. The feed point 1 of the first antenna is not fed, and the feed point 2 of the second antenna is fed to generate a radiation signal. For current flowing in the first metal frame, refer to the related descriptions in FIG. 5B. Details are not described herein again. A current direction on the second metal frame is the same as a current direction from the feed point 2 to port3, so that radiation efficiency of the second antenna in the first metal frame is enhanced.

In FIG. 9B, the electronic device is in the folded state. If the second antenna is fed to generate a radiation signal at a second operating frequency, the first metal frame generates a current 3 in a direction from the feed point 2 to port3 at the second operating frequency. In the foregoing process, the second metal frame couples a radiation signal within the second operating frequency band of the second antenna, and the second metal frame generates a current 4 in a direction from the fourth open end to the third open end within the second operating frequency band. The current 3 is in a same direction as the current 4.

FIG. 9C is a schematic diagram of current flow directions in the first metal frame and the second metal frame at 1.9 GHz when an operating frequency of the first antenna ANT1 is 1.78 GHz. The feed point 2 of the second antenna is not fed, and the feed point 1 of the first antenna is fed to generate a radiation signal. A current direction of the first metal frame is to the right, and a current direction of the second metal frame is to the left.

In FIG. 9C, the first metal frame generates a current 5 in a direction from the first open end to the second open end at a fourth frequency (1.9 GHZ). When the second metal frame is coupled to the first antenna, the second metal frame generates a current 6 in a direction from the fourth open end to the third open end at the fourth frequency. The current 5 is in an opposite direction to the current 6, and the fourth frequency is greater than the first frequency (1.78 GHZ). The fourth frequency may be a resonance frequency of the second metal frame.

FIG. 9D is a schematic diagram of current flow directions in the first metal frame and the second metal frame at 1.9 GHz when an operating frequency of the second antenna ANT2 is 1.72 GHz. The feed point 1 of the first antenna is not fed, and the feed point 2 of the second antenna is fed to generate a radiation signal. A current direction of the first metal frame is to the right, and a current direction of the second metal frame is to the left.

In FIG. 9D, the first metal frame generates a current 7 in a direction from the second open end to the first open end at a fifth frequency (1.9 GHZ). The second metal frame generates, at the fifth frequency, a current 8 in a direction from the third open end to the fourth open end when the second metal frame is coupled to the first antenna. The current 7 is in an opposite direction to the current 8, the fifth frequency is greater than the second frequency, and the fifth frequency is a resonance frequency of the second metal frame.

In FIG. 9C and FIG. 9D, currents in the first metal frame and in the second metal frame at a frequency of 1.9 GHz are currents out of a B3 band (out of operating frequency bands of the first antenna and the second antenna), and the currents in the second metal frame and in the first metal frame are in opposite directions and are of equal amplitude. Therefore, at 1.9 GHZ, energy of a radiation signal of the first antenna and/or a radiation signal the second antenna and energy of a radiation signal of the second metal frame cancel each other out. With reference to FIG. 8B, a local minimum value of antenna efficiency occurs out of the B3 band (1.8 GHz to 2 GHz), so that efficiency and performance of the first antenna and/or the second antenna within the B3 band can be improved.

### Embodiment 2

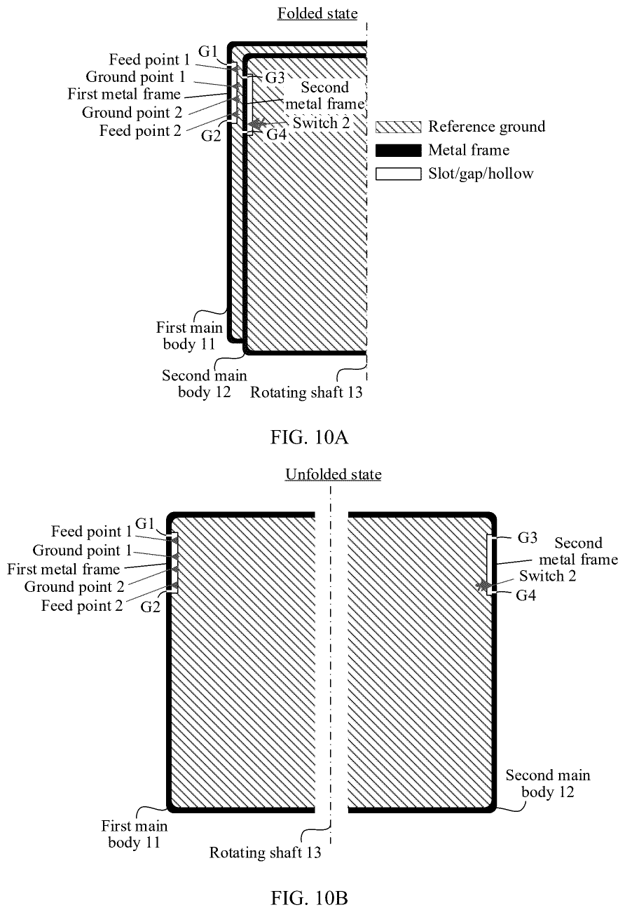

In Embodiment 1, a position where the second metal frame is connected to the third frequency modulation circuit is not limited. Content in FIG. 10A to FIG. 13B describes a specific case in which the third frequency modulation circuit is connected to different positions on the second metal frame.

FIG. 10A and FIG. 10B are another group of schematic diagrams of an antenna system of a foldable electronic device 100 according to an embodiment of this application. FIG. 10A shows an antenna system formed when the electronic device is in a folded state, and FIG. 10B shows an antenna system formed when the electronic device is in an unfolded state.

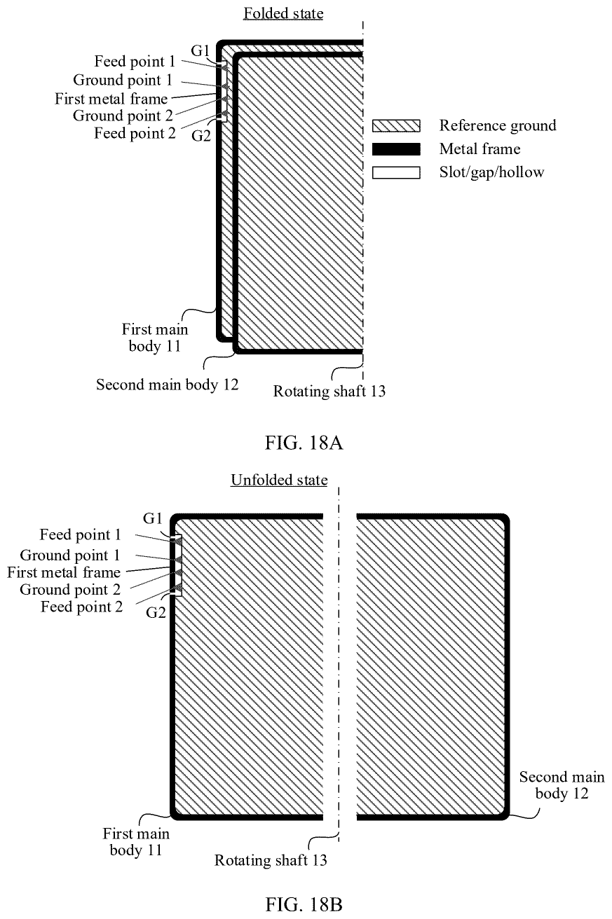

A difference between the antenna system in FIG. 10A and FIG. 10B and the antenna system in FIG. 2A to FIG. 8B lies in that a switch 2 in FIG. 10A and FIG. 10B is disposed on a side that is close to a gap G4 and that is of a second metal frame. The switch 1 in FIG. 2A and FIG. 2B is disposed on a side that is close to the gap G3 and that is of the second metal frame. In FIG. 18A and FIG. 18B, a third frequency modulation circuit includes the switch 2 and N capacitive sensing devices, and may be configured to adjust a frequency of the second metal frame to a third frequency. For a first metal frame, the second metal frame, and a corresponding connection relationship and position relationship, and the like in FIG. 10A and FIG. 10B, refer to related content in FIG. 2A and FIG. 2B. Details are not described herein again.

The following describes radiation performance of the electronic device in the folded state with reference to FIG. 11 to FIG. 13B.

FIG. 11 is a schematic diagram of a structure of an antenna when the electronic device in FIG. 10A is in a folded state. For descriptions of the first metal frame and the second metal frame, G1, G2, G3, and G4, and port1, port2, port3, and port4 in FIG. 11, refer to the related descriptions in FIG. 6. Details are not described herein again. In addition, for a position of port6, refer to the related descriptions of the switch 2 in FIG. 10A and FIG. 10B. Details are not described herein again.

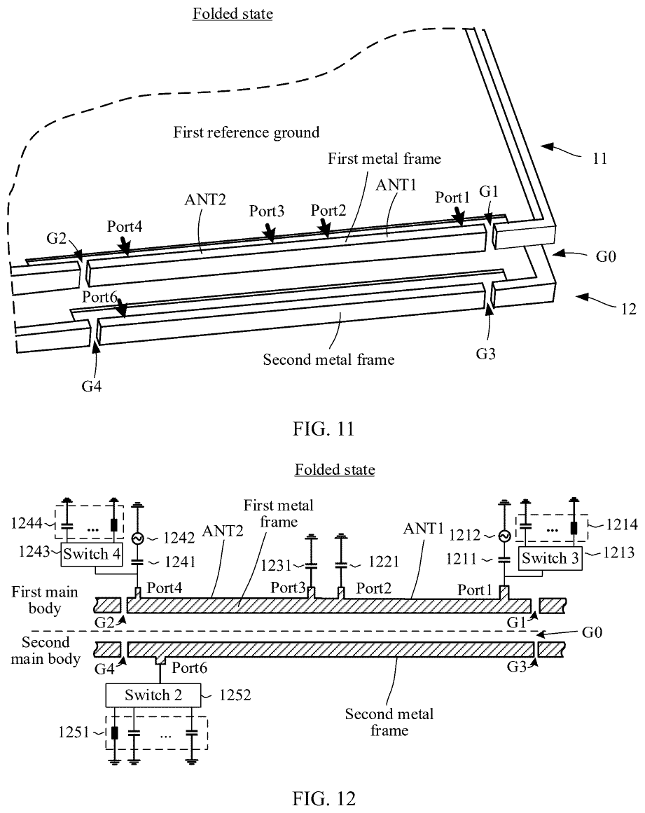

FIG. 12 is a schematic diagram of a circuit structure of an antenna system according to an example embodiment of this application. As shown in FIG. 12, the second metal frame may be connected to the third frequency modulation circuit through port6. The third frequency modulation circuit includes a switch 2 and N capacitive sensing devices. One end of the switch 2 (1252) is similar to the switch 1 in Embodiment 1. Port6 may be connected to the one end of the switch 2 (1252), N selection ends of the switch 2 (1252) may be connected to ends of capacitors or the inductors 1251, and the other ends of the capacitors or inductors 2051 are grounded. In addition, for a connection structure of port1 to port4 in FIG. 12, refer to the related descriptions in FIG. 7. Details are not described herein again.

Through selection of the switch 2, a switch 3, and a switch 4, the first antenna and the second antenna can determine corresponding frequency bands for communication. For example, communication is currently performed within a B3 frequency band, and parameters of the connected capacitors and inductors are as follows: The capacitor 1214 is set to 0.3 pF; the capacitor 1211 is set to 0.4 pF; the capacitor 1221 is set to 6 pF; the capacitor 1231 is set to 15 pF; the inductor 1244 is set to 21 nH; the capacitor 1241 is set to 0.5 pH; and the capacitance 1251 is set to 39 nH.

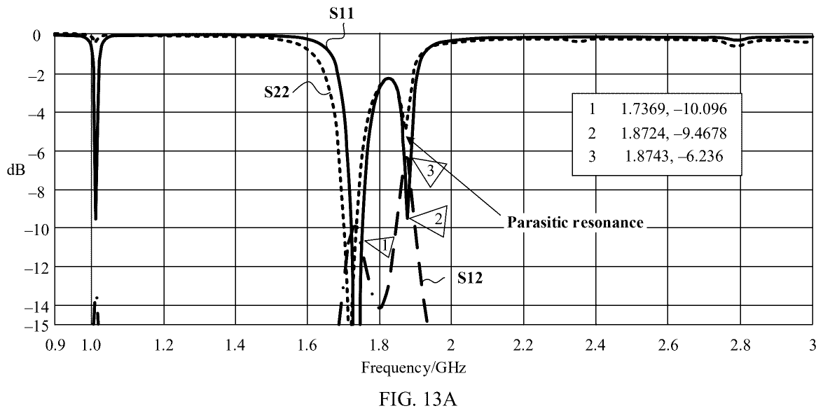

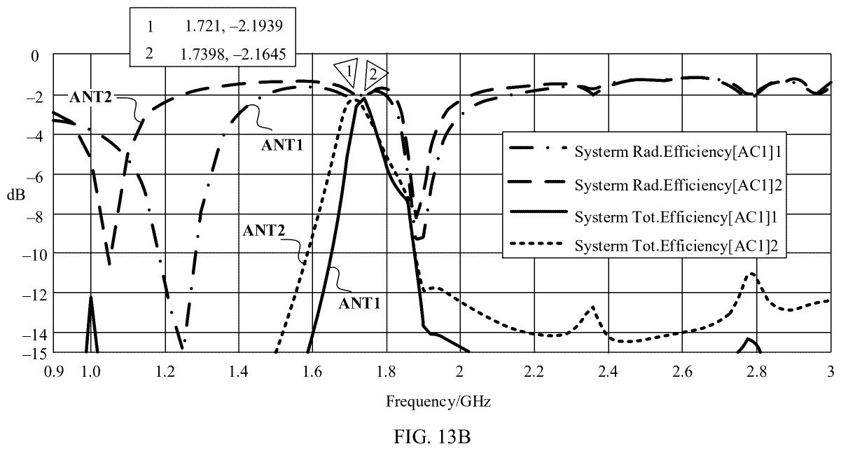

FIG. 13A is a schematic diagram of S-parameter curves of a first antenna and a second antenna when an electronic device is in a folded state. Reference numerals S11 and S22 respectively indicate reflection coefficient curves of the first antenna ANT1 and the second antenna ANT2, and a reference numeral S12 indicates a transmission coefficient curve between the first antenna ANT1 and the second antenna ANT2.

As shown in FIG. 13A, when the electronic device in FIG. 11 is in the folded state, a resonance is generated between the first antenna ANT1 and the second antenna ANT2 within a B3 frequency band, and isolation is approximately-10 dB. Same as Embodiment 1 (FIG. 8A), performance in the folded state can be well improved.

FIG. 13B is a schematic diagram of antenna efficiency curves of a first antenna and a second antenna when an electronic device is in a folded state. Reference numerals Systerm Rad.Efficiency[AC1]1 and Systerm Rad.Efficiency[AC1]2 respectively indicate radiation efficiency curves of the first antenna ANT1 and the second antenna ANT2; and reference numerals Systerm Tot.Efficiency[AC1]1 and Systerm Tot.Efficiency[AC1]2 respectively indicate system efficiency curves of the first antenna ANT1 and the second antenna ANT2.

As shown in FIG. 13B, within the B3 frequency band, antenna efficiency of the first antenna and the second antenna is approximately-2.2 dB. In comparison with Embodiment 1, antenna efficiency is nearly identical. In two radiation efficiency curves in Embodiment 2, a parasite resonance is also generated in the second metal frame within 2.2 GHz to 2.4 GHz. The parasite resonance is presented in the efficiency curve as a minimum value occurring between 1.8 GHz and 2 GHz. This can also improve efficiency of the two antennas in the folded state and also improve isolation of the two antennas.

Comparisons of radiation efficiency and isolation data in the unfolded and in the folded state according to Embodiment 2 are as follows.

TABLE 2

| | First antenna ANT1 | | Second antenna ANT2 | | |
|---|---|---|---|---|---|
| | Frequency | Efficiency | Frequency | Efficiency | S21 |
| | (GHz) | (dB) | (GHz) | (dB) | (dB) |
| Unfolded state | 1.71 | −1.8 | 1.73 | −1.7 | −8.5 |
| Folded state | 1.73 | −2.2 | 1.73 | −2.2 | −10 |
| Efficiency | | −0.4 | | 0.5 | 1.5 |
| change | | | | | |

Table 2 shows the comparisons of the radiation efficiency and the isolation data in the unfolded state and in the folded state in Embodiment 2 according to an example embodiment of this application. As shown in Table 2, in comparison to the unfolded state, in the folded state, efficiency of the first antenna is reduced by 0.4 dB, and efficiency of the second antenna is increased by 0.5 dB. Isolation between the first antenna and the second antenna is increased by 1.5 dB. Therefore, efficiency changes within 0.5 dB, the isolation is increased by approximately 1.5 dB, and overall antenna performance is improved in the folded state.

In general, the antenna structures in Embodiment 1 and Embodiment 2 can achieve good isolation between ports of a multi-input multi-output (multi-input multi-output, MIMO) antenna system, and have features such as high efficiency, miniaturization, and a simple structure. This can meet a performance requirement for the antenna in the field of intelligent terminal communication, is also beneficial to being applied to a miniaturized electronic device with a small clearance area, and can improve communication performance of the electronic device.

### Embodiment 3

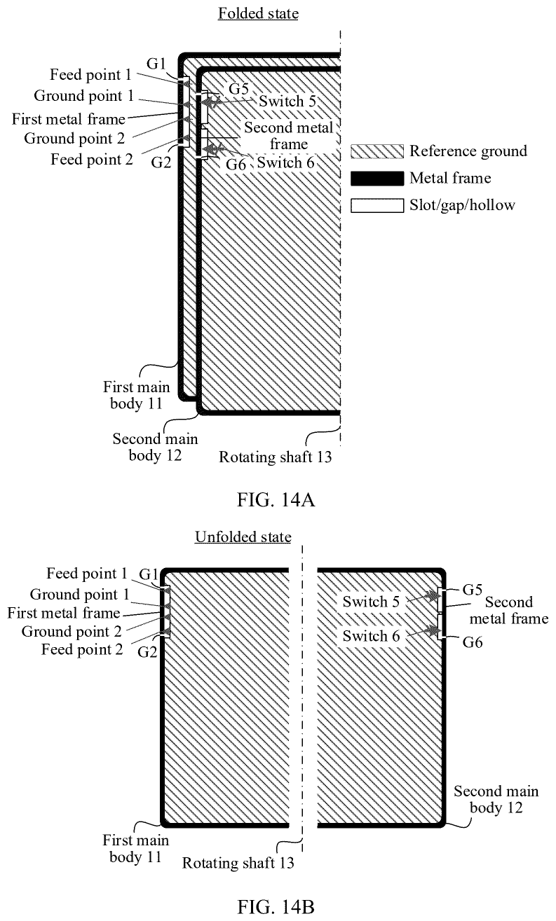

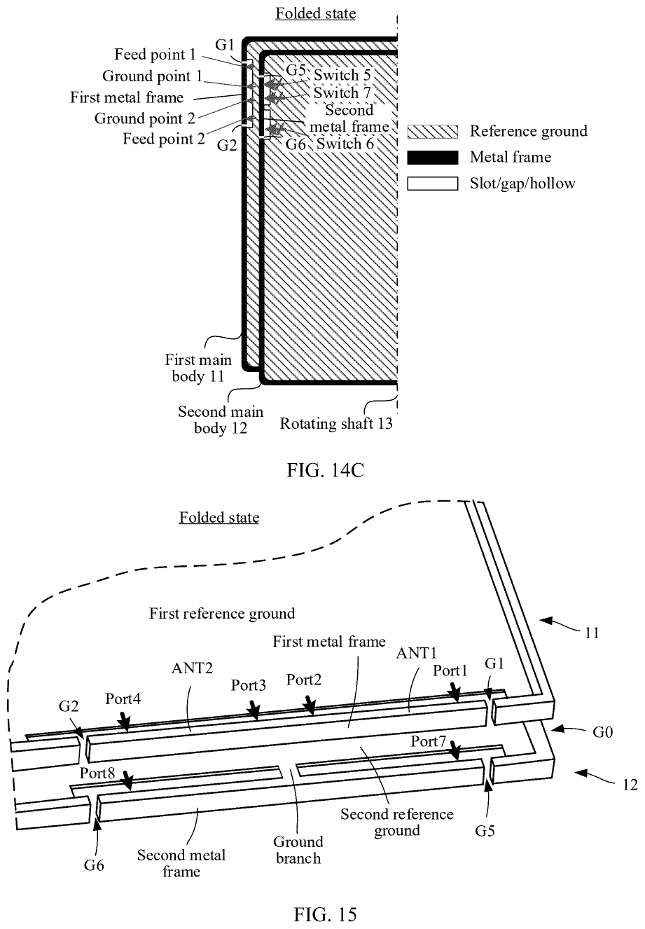

FIG. 14A to FIG. 14C are another group of schematic diagrams of an antenna system of a foldable electronic device according to an implementation of this application. FIG. 14A shows an antenna system formed when the electronic device is in a folded state, and FIG. 14B shows an antenna system formed when the electronic device is in an unfolded state.

In Embodiment 3 shown in FIG. 14A and FIG. 14B, an antenna system on a first main body 11 has a same structure as the antenna in Embodiment 1. For a first metal frame in the first main body 11, refer to the descriptions in FIG. 2A, FIG. 6, and FIG. 7. Details are not described herein again. Similarly, two ends of a second metal frame are open, including a third open end and a fourth open end. There is a gap G5 between the third open end of the second metal frame and a middle frame (a secondary screen frame) of a second main body, and there is a gap G6 between the fourth open end of the second metal frame and the middle frame (the secondary screen frame) of the second main body. Different from Embodiment 1, one ground branch (that is, a ground point 3) and at least two frequency modulation circuits (corresponding to a switch 5 and a switch 6) are disposed on the second metal frame of the second main body 12. The two frequency modulation circuits may be respectively disposed on two sides of the ground branch.

The frequency modulation circuits at the two sides of the ground branch node of the second metal frame are not limited. As shown in FIG. 14C, two frequency modulation circuits (corresponding to the switch 5 and a switch 7) are disposed on one side of the ground branch, and one frequency modulation circuit (corresponding to the switch 6) is disposed on the other side. Certainly, there may be another quantity of frequency modulation circuits on the two sides of the ground branch. This is not limited in this embodiment of this application.

FIG. 15 is a schematic diagram of a structure of an antenna when the electronic device in FIG. 14A is in a folded state according to an embodiment of this application. As shown in FIG. 15, the structure of the first metal frame in the first main body 11 is the same as the structure of the first metal frame in Embodiment 1. For details, refer to the descriptions of the first main body 11 in FIG. 6. Details are not described herein again. In FIG. 15, same as Embodiment 1, the first metal frame is the same as a first position. Two ports port7 and port8, and one ground branch are further provided on a second metal branch. The port port7 may be connected to a frequency modulation circuit, and the port port8 may be connected to another frequency modulation circuit.

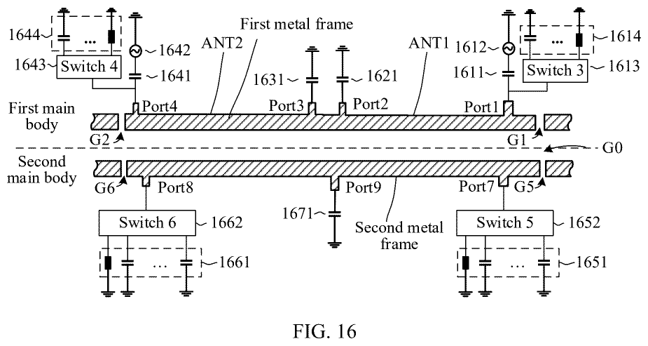

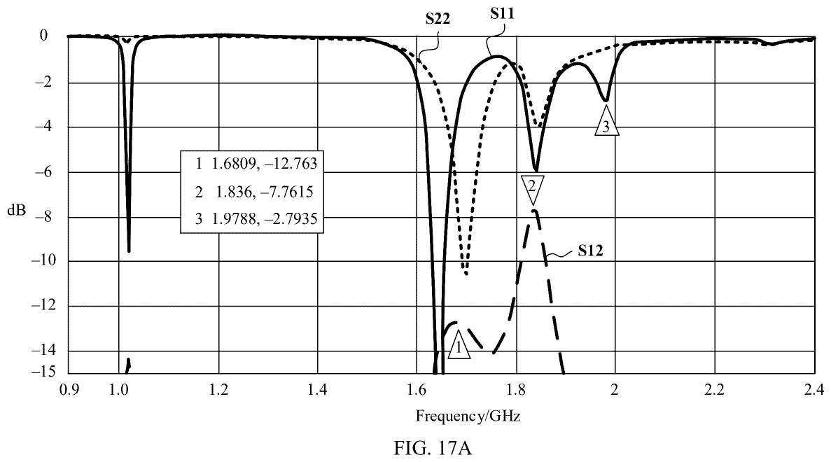

FIG. 16 is a schematic diagram of a circuit structure of an antenna when the electronic device in FIG. 15 is in a folded state according to an embodiment of this application. As shown in FIG. 16, the port port1 of a first antenna ANT1 and the port port4 of a second antenna ANT2 are connected to feed sources, and further connected to frequency modulation circuits. For related descriptions of the frequency modulation circuit, refer to the related descriptions in FIG. 7. Details are not described herein again.

Specifically, the port port1 may be connected to one feed point and one frequency modulation circuit. The port port1 may be connected to one end of a capacitor 1611 and one end of a switch 3 (1613), the other end of the capacitor 1611 is connected to one end of a first feed source 1612, and the other end of the first feed source 1612 is grounded. K selection ports of the switch 3 (1613) are sequentially connected to ends of capacitors or inductors 1614, and the other ends of the capacitors or inductors 1614 are grounded. The capacitors or inductors 1614 include K capacitive sensing devices, where K is an integer greater than 2, and parameters of the capacitors or inductors need to be different.

Correspondingly, the port port4 may also be connected to one feed point and one frequency modulation circuit. The port port4 may be connected to one end of a capacitor 1641 and one end of a switch 4 (1643), the other end of the capacitor 1641 is connected to one end of a second feed source 1642, and the other end of the second feed source 1642 is grounded. M selection ports of the switch 4 (1643) are sequentially connected to ends of capacitors or inductors 1644, and the other ends of the capacitors or inductors 1644 are grounded. The capacitors or inductors 1644 include M capacitive sensing devices, where M is an integer greater than 2, and parameters of the capacitors or inductors need to be different. For details, refer to the descriptions in FIG. 7.

Port7 and port8 of the second metal frame each may be connected to a frequency modulation circuit. Port7 may be connected to one end of a switch 5 (1652), N selection ends of the switch 5 (1652) may be connected to ends of capacitors or inductors 1651, and the other ends of the capacitors or inductors 1651 are grounded. Port8 may be connected to one end of a switch 6 (1662), R selection ends of the switch 6 (1662) may be connected to ends of capacitors or inductors 1661, and the other ends of the capacitors or inductors 1661 are grounded. N and R are also integers greater than 2. The switch 5 and the switch 6 may also be configured to select capacitor or inductor modules of different specifications to be grounded, to enable adaptation to an operating frequency of a corresponding antenna. For details, refer to the related descriptions in FIG. 7. Details are not described herein again.

Similarly, for ground solutions of the ports port2 and port3, refer to the descriptions in FIG. 3B. The port port2 of the first antenna ANT1 may be connected to one end of a capacitor 1621, and the other end of the capacitor 1621 may be grounded. The port port3 of the second antenna ANT2 may be connected to one end of a capacitor 1631, and the other end of the capacitor 1631 may be grounded. In addition, the ground solutions of port2 and Port3 may alternatively be the solutions in FIG. 3A and FIG. 3C. This is not limited in this application.

Through selection of the switch 3, the switch 4, the switch 5, and the switch 6, the first antenna and the second antenna can determine corresponding frequency bands for communication. For example, communication is currently performed within a B3 frequency band, and parameters of the connected capacitors and inductors are as follows: The capacitor 1614 is set to 0.4 pF; the capacitor 1611 is set to 0.4 pF; the capacitor 1621 is set to 6 pF; the capacitor 1631 is set to 15 pF; the inductor 1644 is set to 24 nH; the capacitor 1641 is set to 0.5 pF; the inductor 1651 is set to 56 nH; and the inductor 1661 is set to 15 nH.

A third ground point (corresponding to port9) is disposed on the second metal frame, the third frequency modulation circuit includes a fourth frequency modulation circuit and a fifth frequency modulation circuit, the fourth frequency modulation circuit is disposed on one side of the third ground point, and the fifth frequency modulation circuit is disposed on the other side of the third ground point. Quantities of frequency modulation circuits of the fourth frequency modulation circuit and the fifth frequency modulation circuit each may be greater than or equal to 1. For a ground manner of the third ground point, refer to the three possible manners shown in FIG. 3A to FIG. 3C. In this case, port9 may be grounded through a capacitor 1671.

Optionally, when the electronic device is in the folded state, a projection of the third ground point on a plane on which the first main body is located is between the first ground point and the second ground point. In other words, a projection of port9 on the plane on which the first main body is located is between port2 and port3.

Optionally, when the electronic device is in the folded state, the projection of the third ground point on the plane on which the first main body is located overlaps the first ground point or the second ground point. In other words, a projection of port9 on the plane on which the first main body is located overlaps port2 or port3.

In Embodiment 3, the second metal frame includes the fourth frequency modulation circuit and the fifth frequency modulation circuit. The electronic device may adjust the fourth frequency modulation circuit based on the operating frequency of the first antenna. Specifically, the electronic device may determine the operating frequency of the first antenna as a target operating frequency of the fourth frequency modulation circuit, determine, based on a mapping relationship between frequencies and switch options in the fourth frequency modulation circuit, a switch option corresponding to the target operating frequency, and adjust the fourth frequency modulation circuit to the selected switch option. Similarly, the electronic device may further adjust the fifth frequency modulation circuit based on the operating frequency of the second antenna. A method for adjusting the fifth frequency modulation circuit is the same as the method for adjusting the fourth frequency modulation circuit. Details are not described herein again. In addition, for the method for determining the target operating frequency, refer to the detailed descriptions of the method for improving antenna efficiency in FIG. 7. Details are not described again.

In this case, fourth from the first frequency modulation circuit to the third ground point, a projection of a first segment of the first metal frame on the first main body at least partially overlaps a third segment of the second metal frame. A projection of a second segment of the first metal frame on the first main body at least partially overlaps a fourth segment of the second metal frame. The third segment is a segment from the fourth frequency modulation circuit to the third ground point in the second metal frame. The fourth segment is a segment from the fifth frequency modulation circuit to the third ground point in the second metal frame.

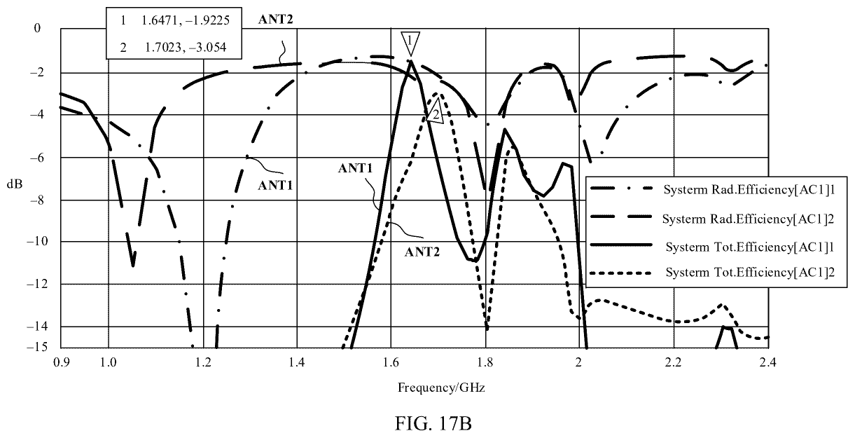

FIG. 17A is a schematic diagram of S-parameter curves of a first antenna and a second antenna when an electronic device is in a folded state. Reference numerals S11 and S22 respectively indicate reflection coefficient curves of the first antenna ANT1 and the second antenna ANT2, and a reference numeral S12 indicates a transmission coefficient curve between the first antenna ANT1 and the second antenna ANT2.

As shown in FIG. 17A, when the electronic device is in the folded state, a resonance is generated between the first antenna ANT1 and the second antenna ANT2 within a frequency band B3, and isolation is −12.7 dB.

FIG. 17B is a schematic diagram of antenna efficiency curves of a first antenna and a second antenna when an electronic device is in a folded state. Reference numerals Systerm Rad.Efficiency[AC1]1 and Systerm Rad.Efficiency[AC1]2 respectively indicate radiation efficiency curves of the first antenna ANT1 and the second antenna unit ANT2; and reference numerals Systerm Tot.Efficiency[AC1]1 and Systerm Tot.Efficiency[AC1]2 respectively indicate system efficiency curves of the first antenna ANT1 and the second antenna ANT2.

As shown in FIG. 17B, within the B3 frequency band, system efficiency of the first antenna is approximately-1.9 dB, and system efficiency of the second antenna is approximately −3 dB. Therefore, a ground point is added in the middle of the second metal frame in Embodiment 3. This design may generate two parasitic resonances following a required resonance, and the two parasitic resonances are represented in the antenna efficiency curves as two minimum values occurring between 1.9 GHz to 2.2 GHz. In Embodiment 3, isolation and antenna performance are better.

### Solution 1: No Processing is Performed at a Position of a Second Main Body Corresponding to a First Metal Frame in a First Main Body.

FIG. 18A and FIG. 18B are another group of schematic diagrams of an antenna system of a foldable electronic device 100 according to an implementation of this application. FIG. 18A shows an antenna system when the electronic device is in a folded state, and FIG. 18B shows an antenna system when the electronic device is in an unfolded state.

In the reference solution 1 shown in FIG. 18A and FIG. 18B, a first metal frame has a same structure as the first metal frame in Embodiment 1. For the structure of the first metal frame, refer to the descriptions in FIG. 2A and FIG. 2B. Details are not described herein again. No special processing is performed at a position of a secondary screen frame that is in a second main body 12 and that corresponds to a first antenna and a second antenna in a first main body 11. In other words, no special processing is performed on an overlapping region (a same position at which the second metal frame is located in Embodiment 1) of a projection of the first metal frame in the first main body on a plane on which the second main body is located, and no processing such as slitting or slotting is performed on a second middle frame. In FIG. 18A, when the electronic device is in the folded state, the overlapping region of the projection of the first metal frame in the first main body on the plane on which the second main body is located is a complete metal frame and reference ground. This leads to blocking and interference to signal radiation of the first antenna and the second antenna, resulting in a poor signal radiation effect.

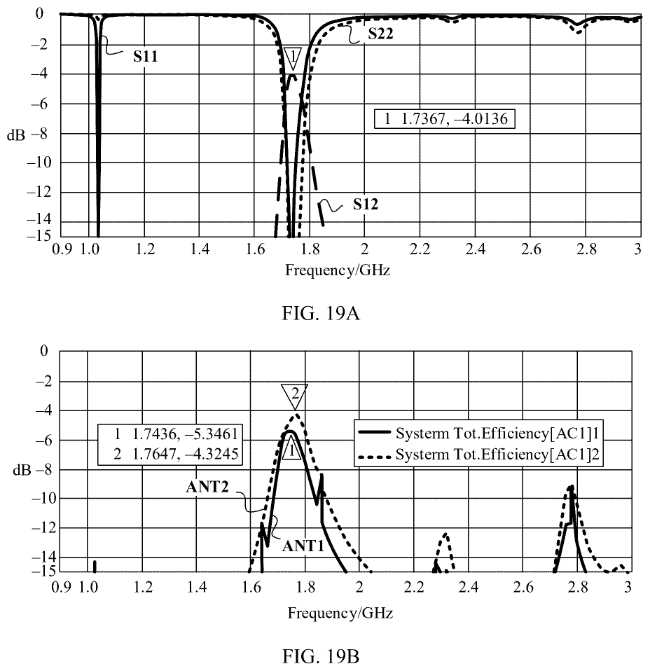

FIG. 19A is a schematic diagram of S-parameter curves of a first antenna and a second antenna when an electronic device is in a folded state. Reference numerals S11 and S22 respectively indicate reflection coefficient curves of the first antenna ANT1 and the second antenna ANT2, and a reference numeral S12 indicates a transmission coefficient curve between the first antenna ANT1 and the second antenna ANT2.

As shown in FIG. 19A, when the electronic device is in the folded state (in FIG. 18A), a resonance is generated between the first antenna ANT1 and the second antenna ANT2 in a B3 frequency band, and isolation is approximately-4 dB. The isolation in Embodiment 1 is approximately-8.5 dB, so that the isolation between the two antennas in Solution 1 is worse.

FIG. 19B is a schematic diagram of antenna efficiency curves of a first antenna and a second antenna when an electronic device is in a folded state. Reference numerals Systerm Tot.Efficiency[AC1]1 and Systerm Tot.Efficiency[AC1]2 respectively indicate system efficiency curves of the first antenna ANT1 and the second antenna ANT2.

As shown in FIG. 19B, system efficiency within a B3 frequency band is approximately −5 dB. Therefore, the efficiency in the solution in Embodiment 1 (approximately-2 dB in FIG. 8B) is improved by approximately 3 dB compared with the efficiency in Solution 1.

Implementation 1 is compared with all the solutions. In this case, no processing is performed on the secondary screen frame corresponding to the two antennas on a main screen frame. Performance in Solution 1 is the poorest, and is greatly deteriorated in the folded state compared with the unfolded state.

### Solution 2: The Second Main Body Corresponding to the First Metal Frame in the First Main Body is Completely Hollowed Out.

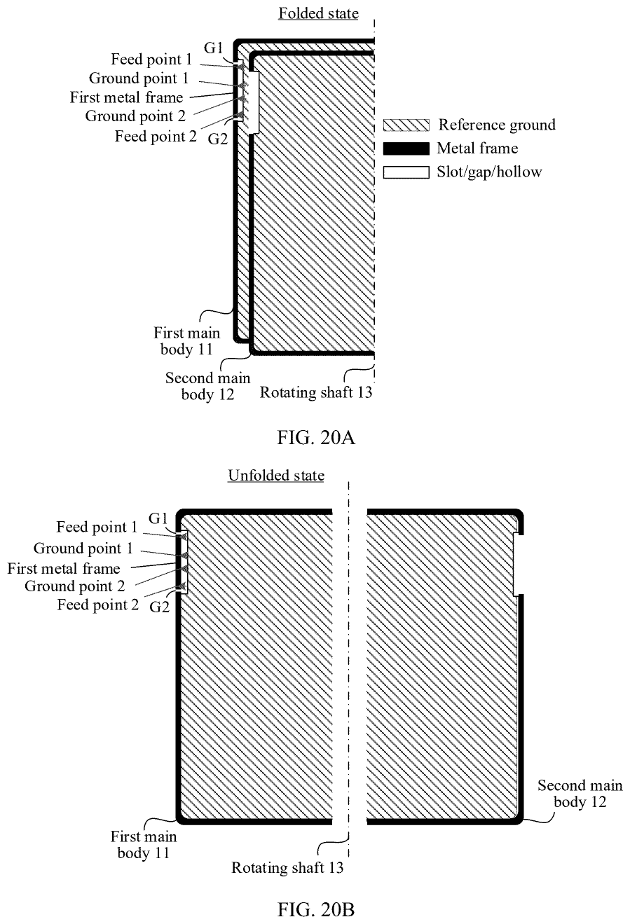

FIG. 20A and FIG. 20B are another group of schematic diagrams of an antenna system of a foldable electronic device 100 according to an implementation of this application. FIG. 20A shows an antenna system when the electronic device is in a folded state, and FIG. 20B shows an antenna system when the electronic device is in an unfolded state.

In Solution 2 shown in FIG. 20A and FIG. 20B, a first metal frame has a same structure as the first metal frame in Embodiment 1. For the first metal frame, refer to the descriptions in FIG. 2A. Details are not described herein again. A secondary screen frame is completely hollowed out at a position (a same position at which the second metal frame is located in Embodiment 1) that is in a second main body 12 and that corresponds to a first antenna and a second antenna in a first main body 11, and is in a hollow shape. In FIG. 20A, when the electronic device is in the folded state, a part that is in the second main body 12 and that overlaps the first antenna and the second antenna has no blocked or overlapped reference ground and metal frame.

In addition, for descriptions of the first antenna, the second antenna, the reference ground, the metal frame, and the slot/gap/hollow in FIG. 18A and FIG. 18B, FIG. 19A and FIG. 19B, and FIG. 20A and FIG. 20B, refer to the related descriptions in FIG. 1A to FIG. 2B. Details are not described herein again.

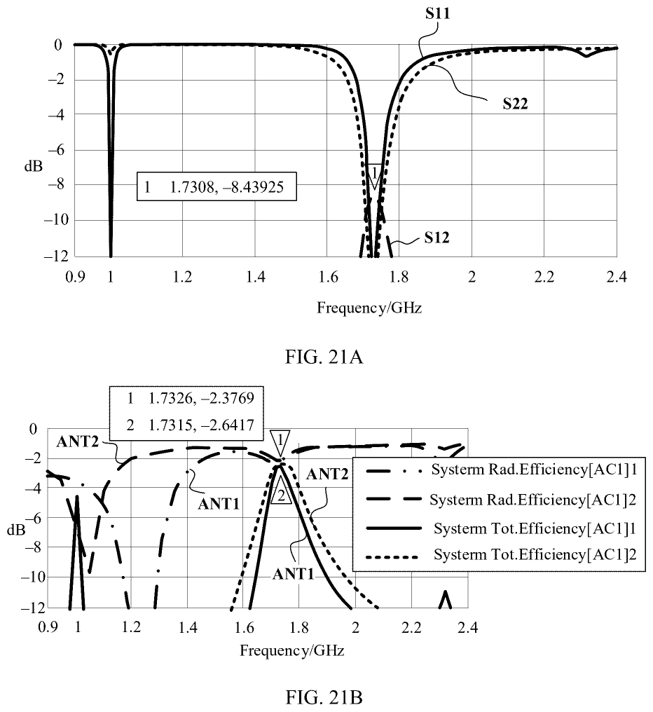

FIG. 21A is a schematic diagram of S-parameter curves of a first antenna and a second antenna when an electronic device is in a folded state. Reference numerals S11 and S22 respectively indicate reflection coefficient curves of the first antenna ANT1 and the second antenna ANT2, and a reference numeral S12 indicates a transmission coefficient curve between the first antenna ANT1 and the second antenna ANT2.

As shown in FIG. 21A, when the electronic device in FIG. 20A is in the folded state, a resonance is generated between the first antenna ANT1 and the second antenna ANT2 within a B3 frequency band, and isolation is approximately-8.5 dB. The isolation in Embodiment 1 is −10 dB, and the isolation in the solution in Embodiment 1 is improved by 1.5 dB compared with the isolation in Solution 2.

FIG. 21B is a schematic diagram of antenna efficiency curves of a first antenna and a second antenna when an electronic device is in a folded state according to an embodiment of this application. Reference numerals Systerm Rad.Efficiency[AC1]1 and Systerm Rad.Efficiency[AC1]2 respectively indicate radiation efficiency curves of the first antenna ANT1 and the second antenna unit ANT2; and reference numerals Systerm Tot.Efficiency[AC1]1 and Systerm Tot.Efficiency[AC1]2 respectively indicate system efficiency curves of the first antenna ANT1 and the second antenna ANT2.

As shown in FIG. 21B, efficiency within the B3 frequency band is approximately-2.5 dB. Therefore, the efficiency in the solution in Embodiment 1 is nearly identical to the efficiency in Solution 2.

Comparisons of radiation efficiency and isolation data in the folded state according to Embodiment 1, Embodiment 3, and Solutions 1 and 2 are as follows.

TABLE 3

| | First antenna ANT1 | | Second antenna ANT2 | | |
|---|---|---|---|---|---|
| | Frequency | Efficiency | Frequency | Efficiency | S21 |
| Folded state | (GHz) | (dB) | (GHz) | (dB) | (dB) |
| Solution 1 | 1.73 | −5.4 | 1.73 | −4.4 | −4.1 |
| Solution 2 | 1.73 | −2.6 | 1.73 | −2.4 | −8.4 |
| Embodiment 3 | 1.65 | −1.9 | 1.7 | −3 | −12.7 |
| Embodiment 1 | 1.75 | −2.5 | 1.73 | −1.7 | −10 |

Table 3 shows the comparisons of the radiation efficiency and the isolation data in Embodiment 1, Embodiment 3, and Solutions 1 and 2 according to an example embodiment of this application. As shown in Table 3, the antenna efficiency and the isolation in Solution 1 are the poorest, and the antenna efficiency in Solution 2 is nearly identical to the antenna efficiency in Embodiment 1. However, the isolation in Embodiment 1 is higher than that in Solution 2 by approximately 1.5 dB. Antenna efficiency in Embodiment 3 is slightly higher than that in Embodiment 1, and the isolation is higher than that in Embodiment 1 by approximately 2.7 dB. However, the second metal frame in Embodiment 3 needs to be connected to at least one more frequency modulation circuit. Therefore, in Embodiment 1 of this application, the second metal frame is constructed on the second main body, and the second metal frame can act as a parasitic element for both ANT1 and ANT2, to improve performance within a plurality of frequency bands of two antennas on the first metal frame in the folded state. In comparison with Embodiment 3, in Embodiment 1, higher antenna performance, lower costs, and simpler tuning are provided. The structure of the second metal frame in Embodiment 3 is more complex, costs are higher, tuning performance is more flexible, and antenna efficiency and isolation are better.

In this application, any one or more of a slot S1, a slot S2, a gap G1, a gap G2, a gap G3, a gap G4, a gap G5, and a gap G6 may be filled with a non-conductive medium, for example, may be filled with polycarbonate (Polycarbonate, PC). In actual application, widths of the slot S1, the slot S2, the gap G1, the gap G2, the gap G3, the gap G4, the gap G5, and the gap G6 may be set based on actual situations. This is not limited in implementations of this application.

In this application, a wavelength in a specific wavelength mode (for example, a half-wavelength mode or a quarter-wavelength mode) of the antenna may refer to a wavelength of signals radiated by the antenna. For example, an antenna in the ½ wavelength mode may generate a resonance at a frequency band of 2.4 GHz. A wavelength in the ½ wavelength mode is a wavelength of a signal radiated by the antenna at the frequency band of 2.4 GHz. It should be understood that a wavelength of a radiated signal in the air may be calculated based on the following formula: Wavelength=Speed of light/Frequency, where the frequency is a frequency of the radiation signal. A wavelength of the radiated signal in a medium may be calculated based on the following formula: Wavelength=(Speed of light/VE)/Frequency, where E is a relative dielectric constant of the medium, and the frequency is the frequency of the radiation signal.

The foregoing descriptions are merely some implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A foldable electronic device, wherein the foldable electronic device comprises a first main body, a second main body, and a rotating shaft, the first main body and the second main body are connected to each other through the rotating shaft, and the foldable electronic device is foldable at the rotating shaft, wherein
the first main body comprises a first metal frame, the first metal frame comprises a first open end and a second open end, a first ground point and a second ground point are disposed on the first metal frame, a first feed point is disposed between the first ground point and the first open end, and a second feed point is disposed between the second ground point and the second open end; and
the second main body comprises a second metal frame, and two ends of the second metal frame are open.

2. The foldable electronic device according to claim 1, wherein the second metal frame is of a floating structure.

3. The foldable electronic device according to claim 1, wherein when the foldable electronic device is in a folded state, a projection of the second metal frame on a plane on which the first main body is located at least partially overlaps the first metal frame.

4. The foldable electronic device according to claim 3, wherein at least partially overlapping specifically comprises:
the projection of the second metal frame on the plane on which the first main body is located overlaps at least half of a first segment of the first metal frame in a length direction, and the first segment of the first metal frame is a metal frame from the first open end to the first ground point; or
the projection of the second metal frame on the plane on which the first main body is located overlaps at least half of a second segment of the first metal frame in a length direction, and the second segment of the first metal frame is a metal frame from the second open end to the second ground point.

5. The foldable electronic device according to claim 3, wherein the at least partially overlapping specifically comprises:
the projection of the second metal frame on the plane on which the first main body is located completely overlaps the first metal frame.

6. The foldable electronic device according to claim 3, wherein the foldable electronic device further comprises a first antenna and a second antenna that are disposed on the first main body;
the first metal frame comprises a first segment and a second segment, the first segment of the first metal frame is a metal frame from the first open end to the first ground point, and the second segment of the first metal frame is a metal frame from the second open end to the second ground point; and
the first antenna comprises the first segment of the first metal frame, and the second antenna comprises the second segment of the first metal frame.

7. The foldable electronic device according to claim 4, wherein the foldable electronic device further comprises a first antenna and a second antenna that are disposed on the first main body;
the first metal frame comprises the first segment and the second segment, the first segment of the first metal frame is a metal frame from the first open end to the first ground point, and the second segment of the first metal frame is a metal frame from the second open end to the second ground point; and
the first antenna comprises the first segment of the first metal frame, and the second antenna comprises the second segment of the first metal frame.

8. The foldable electronic device according to claim 5, wherein the foldable electronic device further comprises a first antenna and a second antenna that are disposed on the first main body;
the first metal frame comprises a first segment and a second segment, the first segment of the first metal frame is a metal frame from the first open end to the first ground point, and the second segment of the first metal frame is a metal frame from the second open end to the second ground point; and
the first antenna comprises the first segment of the first metal frame, and the second antenna comprises the second segment of the first metal frame.

9. The foldable electronic device according to claim 6, wherein the foldable electronic device is configured such that, when the first antenna is fed at a first frequency, the first metal frame generates a first current in a direction from the first feed point to the first ground point at the first frequency; and
when the second metal frame is coupled to the first antenna, the second metal frame generates, at the first frequency, a second current in a direction from a third open end to a fourth open end, wherein the first current is in a same direction as the second current.

10. The foldable electronic device according to claim 9, wherein the first metal frame generates a third current in a direction from the first open end to the second open end at a fourth frequency; and
the second metal frame generates, at the fourth frequency, a fourth current in a direction from the fourth open end to the third open end, wherein the third current is in an opposite direction to the fourth current, and the fourth frequency is greater than the first frequency.

11. The foldable electronic device according to claim 6, wherein the foldable electronic device is configured such that, when the second antenna is fed at a second frequency, the first metal frame generates a fifth current in a direction from the second feed point to the second ground point at the second frequency; and
when the second metal frame is coupled to the second antenna, the second metal frame generates, at the second frequency, a sixth current in a direction from a fourth open end to a third open end, wherein the fifth current is in a same direction as the sixth current.

12. The foldable electronic device according to claim 11, wherein the first metal frame generates a seventh current in a direction from the second open end to the first open end at a fifth frequency; and
the second metal frame generates, at the fifth frequency, an eighth current in a direction from the third open end to the fourth open end, wherein the seventh current is in an opposite direction to the eighth current, and the fifth frequency is greater than the second frequency.

13. The foldable electronic device according to claim 6, wherein a resonance frequency of the first antenna is a first frequency, a resonance frequency of the second antenna is a second frequency, and the first frequency and the second frequency both fall within a range of a cellular frequency band.

14. The foldable electronic device according to claim 13, wherein the first frequency is the same as the second frequency.

15. The foldable electronic device according to claim 1, wherein a distance between the first ground point and the first open end is less than a distance between the second ground point and the first open end; and a distance between the second ground point and the second open end is less than a distance between the first ground point and the second open end.

16. The foldable electronic device according to claim 6, wherein a length of the second metal frame is greater than or equal to ½ of a first wavelength, the first wavelength is a larger value of a first operating wavelength and a second operating wavelength, the first operating wavelength is a wavelength of a radiation signal of the first antenna, and the second operating wavelength is a wavelength of a radiation signal of the second antenna.

17. The foldable electronic device according to claim 6, wherein the first segment of the first metal frame is connected to a first frequency modulation circuit, and the first frequency modulation circuit is configured to adjust a resonance frequency of the first antenna to a first frequency;
the second segment of the first metal frame is connected to a second frequency modulation circuit, and the second segment is configured to adjust the resonance frequency of the second antenna to a second frequency; and
the second metal frame is connected to a third frequency modulation circuit which is configured to adjust the resonance frequency of the second metal frame to a third frequency, wherein
the third frequency is the same as the first frequency, and/or the third frequency is the same as the second frequency.

18. The foldable electronic device according to claim 17, wherein a third ground point is disposed on the second metal frame, the third frequency modulation circuit comprises a fourth frequency modulation circuit and a fifth frequency modulation circuit, the fourth frequency modulation circuit is disposed on one side of the third ground point, and the fifth frequency modulation circuit is disposed on the other side of the third ground point.

19. The foldable electronic device according to claim 18, wherein when the foldable electronic device is in the folded state, a projection of the third ground point on the plane on which the first main body is located is between the first ground point and the second ground point.

20. The foldable electronic device according to claim 18, wherein when the foldable electronic device is in the folded state, a projection of the third ground point on the plane on which the first main body is located overlaps the first ground point or the second ground point.
